(19) United States
(12) Patent Application Publication
(10) Pub. No.: US 2004/0220947 A1
(43) Pub. Date: Nov. 4, 2004

(54) Method and apparatus for real-time intelligent workload reporting in a heterogeneous environment

(75) Inventors: Jeffrey D. Aman, Poughkeepsie, NY (US); David V. Bostjancic, Poughkeepsie, NY (US); Donna N. Eng Dillenberger, Yorktown Heights, NY (US); Gregory M. Dritschler, Poughkeepsie, NY (US); Mark F. Hulber, New York, NY (US); Mark W. Johnson, Austin, TX (US); Hiren R. Shah, Highland, NY (US); Alan M. Webb, Ridgefield, CT (US); Peter B. Yocom, LaGrangeville, NY (US)

Correspondence Address: William A. Kinnaman, Jr., IBM Corporation - MS P386, 2455 South Road, Poughkeepsie, NY, 12601, US

(73) Assignee: International Business Machines Corporation, Armonk, NY (US)

(21) Appl. No.: 10/428,893

(22) Filed: May 2, 2003

(51) Int. Cl. G06F 7/00

(52) U.S. Cl. 707/100

(57) ABSTRACT

Workload reporting is provided in a distributed transaction processing environment having call trees in which a child application performs a child transaction on behalf of a parent application performing a parent transaction. When a parent application starts a transaction, it makes a call to a reporting agent, passing to it any parent correlator the parent application may have received from a calling application. The reporting agent returns to the parent application a child correlator, which the parent application passes to any child application it calls to perform child transactions. The child correlator contains end-to-end information classifying the parent transaction as well as a hop count indicating the depth of the child application in the call tree. The reporting agent uses the hop count to construct a topology in which commonly classified applications are grouped according to their depth in the call tree for better visualization of performance of individual applications.

### BACKGROUND OF THE INVENTION

1. Field of the Invention

This invention relates a method and apparatus for providing workload reporting in a distributed transaction processing environment, especially a heterogeneous environment in which transactions involve “hops” between applications that may reside on different systems.

2. Description of the Related Art

Workload management is a concept whereby units of work (processes, threads, etc.) that are managed by an operating system are organized into classes (referred to as service classes or goal classes) that are provided system resources in accordance with how well they are meeting predefined goals. Resources are reassigned from a donor class to a receiver class if the improvement in performance of the receiver class resulting from such reassignment exceeds the degradation in performance of the donor class, i.e., there is a net positive effect in performance as determined by predefined performance criteria. Workload management of this type differs from the run-of-the-mill resource management performed by most operating systems in that the assignment of resources is determined not only by its effect on the work units to which the resources are reassigned, but also by its effect on the work units from which they are taken.

Workload managers of this general type are disclosed in the following commonly owned patents, pending patent applications and non-patent publications, incorporated herein by reference:

U.S. Pat. No. 5,504,894 to D. F. Ferguson et al., entitled “Workload Manager for Achieving Transaction Class Response Time Goals in a Multiprocessing System”;

U.S. Pat. No. 5,473,773 to J. D. Aman et al., entitled “Apparatus and Method for Managing a Data Processing System Workload According to Two or More Distinct Processing Goals”;

U.S. Pat. No. 5,537,542 to C. K. Eilert et al., entitled “Apparatus and Method for Managing a Server Workload According to Client Performance Goals in a Client/Server Data Processing System”;

U.S. Pat. No. 5,603,029, to J. D. Aman et al., entitled “System of Assigning Work Requests Based on Classifying into an Eligible Class Where the Criteria Is Goal Oriented and Capacity Information is Available”;

z/OS MVS Planning: Workload Management, IBM publication SA22-7602-05, Dec. 2002;

z/OS MVS Programming: Workload Management Services, IBM publication SA22-7619-03, Oct. 2002.

U.S. Pat. Nos. 5,504,894 and 5,473,773 disclose basic workload management systems; U.S. Pat. No. 5,537,542 discloses a particular application of the workload management system of U.S. Pat. No. 5,473,773 to client/server systems. The two non-patent publications describe an implementation of workload management in the IBM® z/OS™ (formerly MVS®) operating system.

In a distributed transaction processing environment, performance management of cross-platform, cross-middleware application is very cumbersome. Most performance tools are targeted to identify performance problems at an individual server level. For example, log files are produced by Web servers to examine the processing of the HTTP requests, database tools can be used to understand if supporting databases look “normal”. The vast amount of data available, however, bears little relationship to whether the application is delivering service to external requests as expected. Understanding overall performance of applications that span a mix of platforms is a arduous task. Systems that appear to be functioning well on their own, may not be contributing to optimal end-to-end processing of an heterogeneous application.

When performance problems do occur, the maintainers of a distributed transaction processing environment (“end users” for the purposes of this specification) frequently spend hours, or even days, to identify the source of problem. Is a specific server misbehaving? Is a server down? Is the problem with an individual application server process or with a connection from application server process to database server? Existing system management tools having an individual server hardware and operating system perspective can emit false alerts when static performance threshold metrics are exceeded (such as server is more than 80% busy) but fails to alert when an application performance is subnormal.

A few examples will further explain the nature of the problem. A typical distributed transaction processing environment (often called a “server farm”) generally consists of multiple “tiers” of server operating system instances, with each tier configured to provide a specific set of functional capabilities. The selection of hardware and operating system platforms for each tier is in most cases driven by which of the alternatives is most suitable for the intended role. FIG. 1 depicts a simplified, flattened view of a server farm 100, consisting of three physical server tiers: a Web server / edge server tier 102, a Web application server (WAS) tier 104, and a transaction server/database server tier 106.

The Web server/edge server tier 102 services external requests arriving over an Internet attachment to the internal information technology (IT) fabric, servicing primarily HTTP (Hypertext Transfer Protocol) connection protocols. Non-static requests result in an additional “hop” from the edge server 102 to the Web application server tier 104, which may then do a level of Web page composition and/or application business logic. For some requests the Web application server tier 104 may bridge to the transaction server/database server tier 106.

While the preceding example is useful for some purposes, many real end user environments do not actually map all that well. Rather than having one clearly delineated server farm, the customer configuration actually consists of a set of one or more server homesteads, pockets of specialized servers supporting a single application. Evolution of the server environment entails growth of individual homesteads, addition of new homesteads, and the introduction of relationships and/or shared functionality between the various homesteads. The evolutionary introduction of homesteads and relationships between homesteads has one significant implication: that the flow of work through the servers of the server farm can no longer be easily related to the simple physical diagrams of the individual application-centric homesteads.

FIG. 2 shows a simple example of a server farm 200 consisting of several related application islands 202, where interconnections between several homesteads result in application work request flows hopping across multiple tiers. Such an example can be easily extrapolated to reflect a real customer environment consisting of hundreds of server instances, spread across five or more server homesteads.

The actual flow of work through such an environment is dynamic, determined by static configuration information within routers, network dispatchers, and dynamically determined by programming logic provided by Web server plug-ins and application servers. The net effect is that the evolutionary introduction of relationships between application homesteads erodes the ability of an analyst to understand the simplest of concepts, such as what workloads are impacted when a server fails or which servers could be the root cause of the slowdown when a workload slowdown is occurring. The inability to rapidly answer such simple questions surfaces in customer environments in a variety of ways, the most notable being lower productivity for analysts and engineers supporting the environment, reduced application availability for extended periods when problems are occurring, and elongated time-to-deployment of new applications for which additional cross-homestead interactions are knowingly being introduced.

In a nutshell, the complexity of managing the performance of such environments provides the technical motivation for the present invention. The challenges, however, are in reality far greater than the simple diagrams of FIGS. 1-2 can portray. Real environments are populated with server hardware from different manufacturers having different underlying architectures, with multiple server operating systems, running application programs and application middleware environments each having a unique structural architecture and a self-centered view of the world. The transaction server and database server in the example can each be, in itself, a very large multi-tiered cluster of servers. Each element of such an environment is in all likelihood already instrumented for performance analysis, providing a means to extract performance data and to set performance “knobs” when the desired results are not being achieved. Web server issues can be examined with Web log analysis tools, WebSphere exposes information to help one understand the flow and performance of application server work, and the transaction and database servers have a long and rich history of exposing analytical data. These tools are ineffective, however, when the individual components have been properly tuned to the degree which a human can relate to, while the real problem is one of a misunderstanding of the actual relationship between some of the supporting components. The probability of such misunderstandings occurring is rapidly increasing as the simplicity with which any application developer can quickly establish new relationships between components; one line of code can be introduced changing the nature of the server farm forever, and such a change occurs without the need for a new “wiring diagram” or “server farm topology map” which IT infrastructure organizations see, and approve of, in advance.

### SUMMARY OF THE INVENTION

The present invention contemplates a workload reporter, more particularly, a method and apparatus for providing workload reporting in a distributed transaction processing environment having a call tree in which a child application performs a child transaction on behalf of a parent application performing a parent transaction. In accordance with the invention, each such application is associated with a hop count indicating the depth of the application in the call tree. The hop count associated with each application is used to construct a topology of the transaction processing environment in which the applications are represented in accordance with their depth in the call tree.

Preferably, the hop count is propagated between applications by having the parent application pass to the child application a correlator containing the hop count and correlating the parent transaction and the child transaction. Upon receiving notification of the beginning of a parent transaction from a parent application, the workload reporter issues the parent application a child correlator to be passed on to a child application and containing a hop count indicating the depth of the child application in the call tree. The child application presents the child correlator to the workload reporter when it notifies the workload reporter of the beginning of a child transaction. Upon receiving the child correlator from the child application, the workload reporter uses the hop count in the child correlator to construct a topology of the transaction processing environment in which the child application is represented in accordance with its depth in the call tree.

The notification of the beginning of the transaction from the parent application may contain a parent correlator containing a hop count indicating the depth of the parent application in the call tree. In such a case, the workload reporter generates the hop count for the child correlator by incrementing the hop count in the parent correlator.

In addition to containing a hop count, the correlator passed from the parent application to the child application contains end-to-end information commonly classifying transactions in the call tree. The classifying information may indicates a service class, a reporting class, or the like to which the transaction is assigned. In constructing the topology, the workload reporter uses the end-to-end information to classify the child transaction. If the notification of the beginning of the transaction from the parent application contains a parent correlator, the workload reporter generates the end-to-end information for the child correlator from the end-to-end information in the parent correlator.

The distributed transaction processing environment may comprise a plurality of systems, each of which contains one or more applications. In such a case, the workload reporter includes a local agent on each system, which interacts with the applications on that system and maintains a local set of transaction data (including topology information) for applications on that system. The local agent on each system updates its local transaction data upon the completion of a transaction by an application on that system. Periodically the local agents transmit their local transaction data to a central collector, which aggregates the local transaction data to generate a set of global transaction data for a particular reporting domain. The central collector also maintains a copy of a policy that is generated by an administrator. The policy specifies criteria for assigning transactions to particular service classes and reporting classes and is disseminated to the various local agents for their use in classifying transactions.

The present invention solves the problem of performance reporting in heterogeneous environment. This invention provides methods using which the various external work requests serviced by application components can be logically grouped and associated with service class defined by an administrator. Regardless of which server is hosting the application components, the work request will be consistently associated with the same service class on each server. This logical grouping of work requests allows synchronization of the end user view of business expectations and reduces the amount of data required to understand the performance behavior of each application and server serving the application.

The workload report generated in real time by this invention simplifies performance administrator's job. With a single mouse click an administrator can immediately understand if the application is performing as expected. This requires no analytical effort, nor does it require any understanding whatsoever of the status of the various supporting hardware, operating system or application processes. With a quick glance at the workload report, one can determine whether one “should be worried”.

If the application administrator “Should be worried” or is merely curious, an additional mouse click can rapidly decompose the information collected about a specific service class. The decomposition includes the recent response times, a topology map showing the specific set of servers supporting the service class and the contribution of each participating server toward a typical response time for the service class. This allows one to immediately identify the server image which is delivering subnormal performance.

The workload report can be further analyzed to identify the application process which could be contributing towards the subnormal performance of the server. The existing tools then can be used to complete the analysis of the problem rapidly.

Within such an environment, the role of the workload reporter of the present invention is to:

1. Provide analysts with an understanding of the actual flow of work, reflecting the reality of what is taking place; to be effective this must be based upon dynamic discovery, without having any predefined, pre-configured notions of what should be occurring.

2. Present information in simple, logical ways allowing analysts to rapidly and efficiently identify the likely origin of performance problems; a bridge to the appropriate low-level performance analysis tool should be established within minutes, rather than hours or days.

This simple approach requires looking at data at multiple levels. Initially an end user is only concerned with whether the application environment is performing as expected. This requires end-to-end data for all work requests in the application environment. If a problem is identified at this level, more specific data is needed to identify the specific servers and processes that are supporting the work requests and that may be malfunctioning.

The workload reporter of the present invention provides several benefits over existing performance analysis tools:

1. Reduction in amount of performance data need to be collected and post processed at each server.

2. Instantaneous topology map that ties various work segments to the server serving each segment

3. Comparative performance analysis of all the servers that are playing similar role.

4. Very easy to use and configure.

The invention is preferably implemented as computer software running on one or more hardware machines. Such a software implementation contains logic in the form of a program of instructions that are executable by the hardware machines to perform the method steps of the invention. The program of instructions may be embodied on a program storage device comprising one or more volumes using semiconductor, magnetic, optical or other storage technology.

### BRIEF DESCRIPTION OF THE DRAWINGS

FIG. 1 shows an example of a typical distributed transaction processing environment.

FIG. 2 shows an example of a distributed transaction processing environment consisting of several related application islands.

FIG. 3 shows at a global level an example of a typical distributed transaction processing environment incorporating the workload reporter of the present invention.

FIG. 4 shows the Open Group Application Response Measurement (ARM) interfaces that are invoked by applications to provide the necessary instrumentation.

FIG. 5 shows the collection of data by the management server in the system shown in FIG. 3.

FIG. 6 shows a policy used by the workload reporter.

FIG. 7 shows at a system level a distributed transaction processing environment incorporating the workload reporter of the present invention.

FIG. 8 shows the structure of the ARM implementation on each system of the distributed transaction processing environment shown in FIG. 7.

FIG. 9 shows an example of an application topology.

FIG. 10 illustrates how classification is performed.

FIG. 11 shows an example of multiple applications that are distributed across multiple servers.

FIG. 12 shows how applications call the ARM API when a transaction starts and ends.

FIG. 13 illustrates how the workload reporter collects transaction data from the ARM API.

FIG. 14 shows a logical view of the hierarchy of the data kept in the ServerStatisticsAccumulator for service classes.

FIGS. 15-16 show the structure of the ServerStatisticsAccumulator data structure.

FIG. 17 shows the logical structure of the local report class data structure.

FIG. 18 shows an overview of the interactions between the data agent and the ARM services layer.

FIG. 19 shows a logical view of the GlobalStatisticsAccumulator data structure for service classes.

FIG. 20 shows a sample topology graph.

FIG. 21 shows a service class report.

FIG. 22 shows the selection of Service ClassTopology Graph to view the logical tiers.

FIG. 23 shows a service class topology graph.

FIG. 24 shows the selection of application instance level reporting.

FIG. 25 shows an example of systems reporting.

FIG. 26 shows the procedure for generating child correlators.

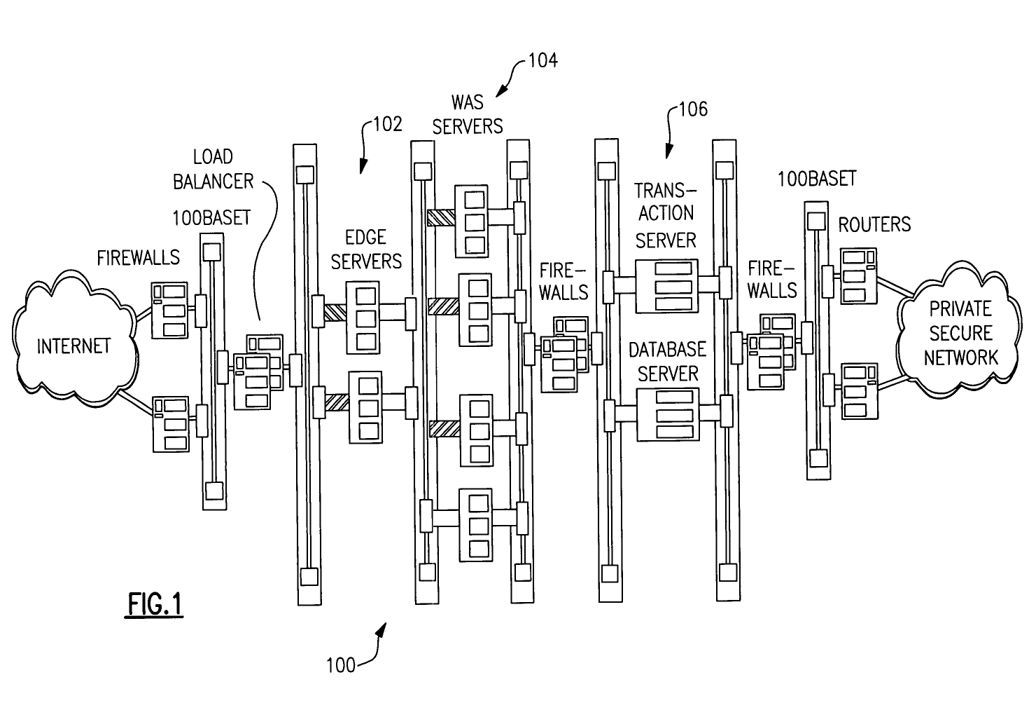

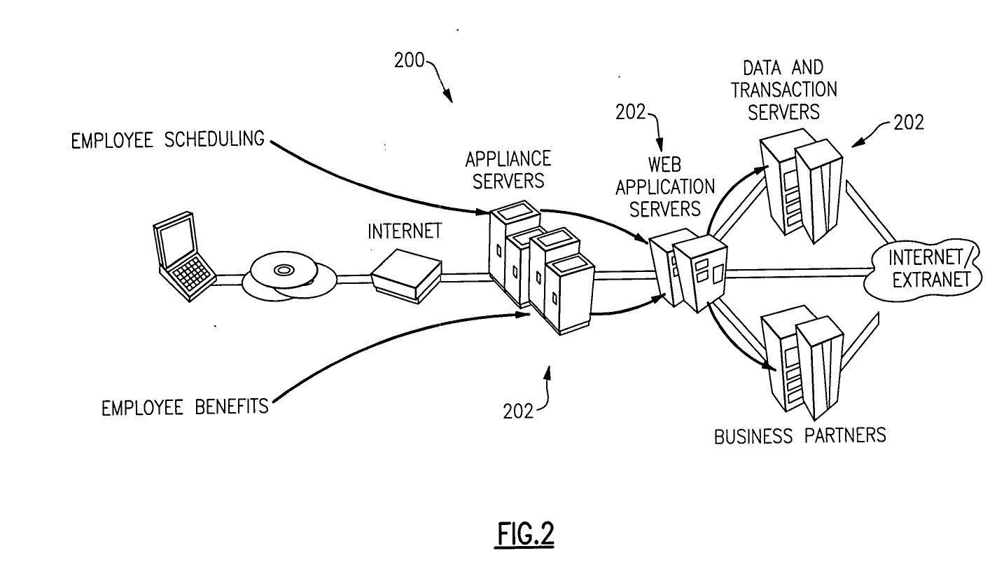

### DESCRIPTION OF THE PREFERRED EMBODIMENTS

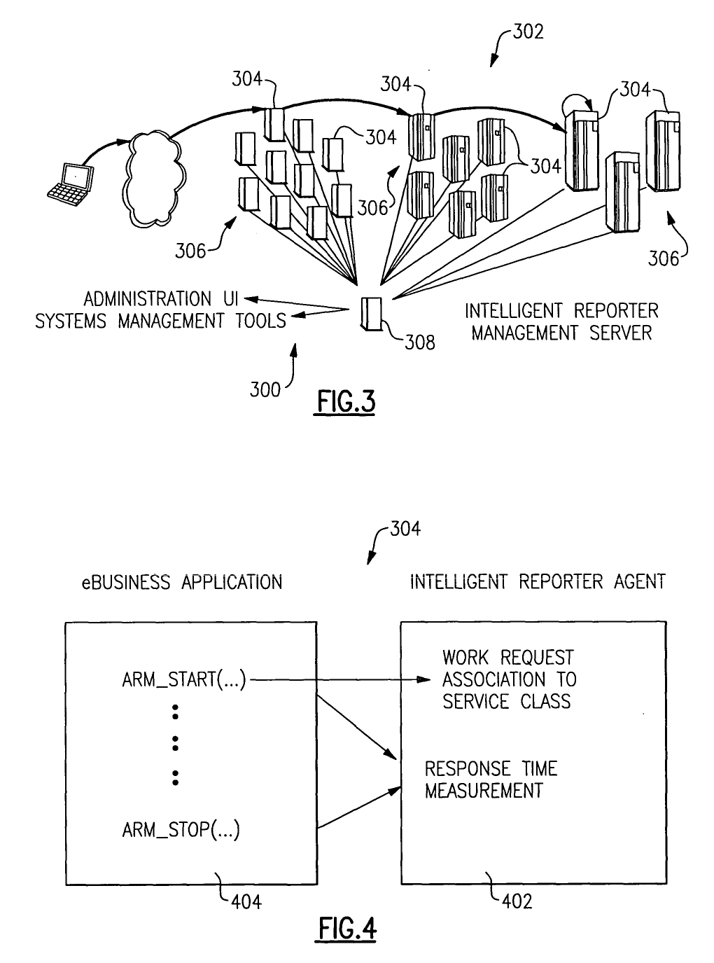

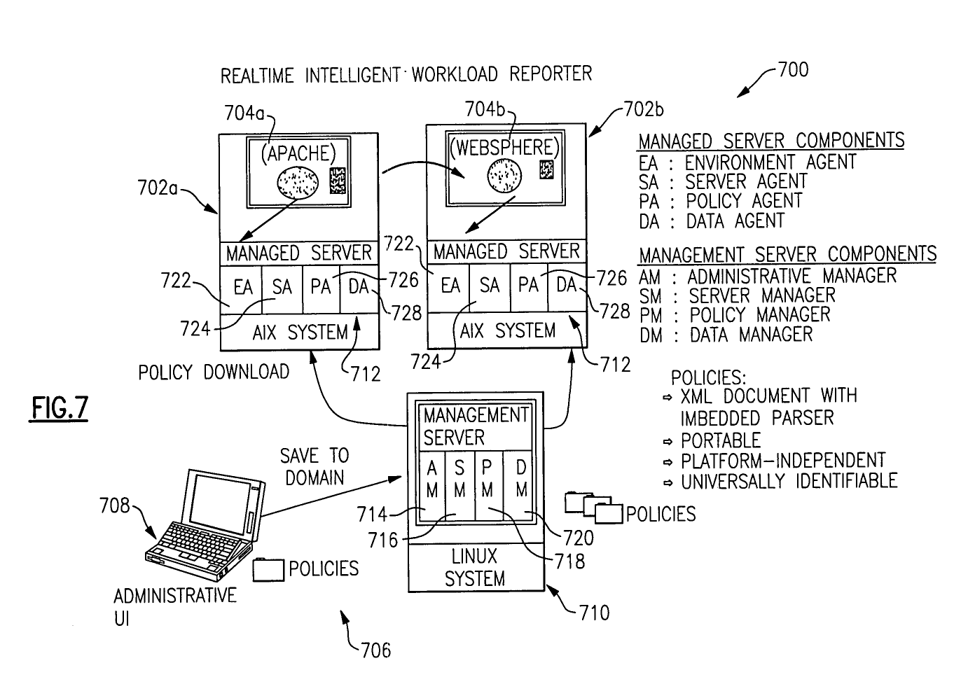

The workload reporter of the present invention will first be described on a global level, with reference to FIGS. 3-5. It will then be described at more of an individual system level, beginning with FIG. 7.

FIG. 3 shows at a global level the general configuration of the workload reporter 300 of the present invention from a global perspective. The workload reporter 300 operates in a distributed transaction processing environment 302 (also referred to herein as a “server farm”) containing one or more systems 304 (also referred to herein as “servers”), which may be grouped into discrete “homesteads” or “islands” 306. As shown in FIG. 3, an administrator installs a policy on what is referred to herein as a management server 308. The policy describes the service level objectives for the end user's distributed transaction processing environment. Each server 304 that is part of the distributed transaction processing environment obtains the policy from the management server 308 and activates it locally.

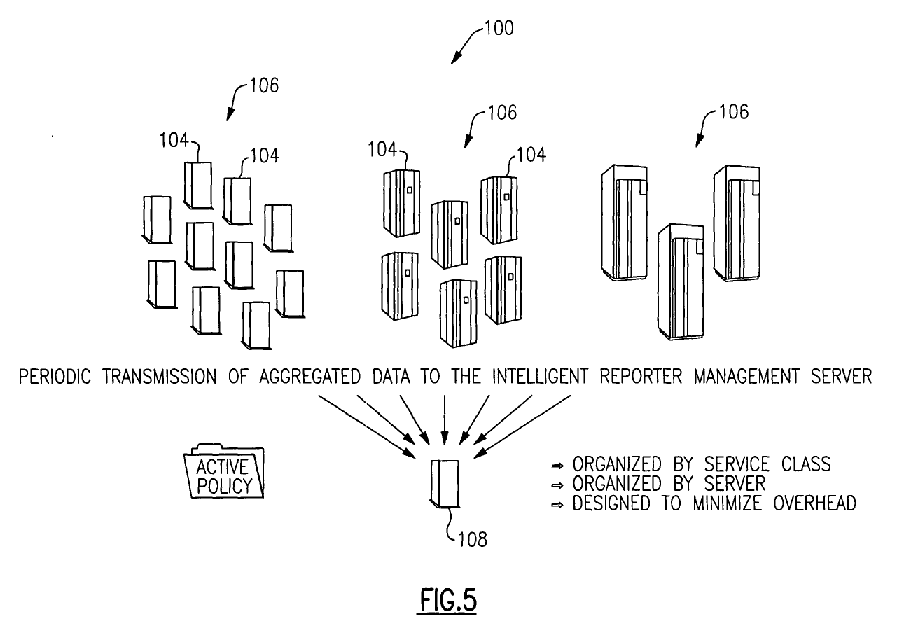

Referring now also to FIG. 4, each system 304 contains a local agent 402 (also referred to herein as a “managed server” or as a “workload manager” or “WLM”) and one or more instrumented applications 404. When a work request (also referred to herein as a “transaction”) enters the server farm 302, the instrumented application 404 serving the work request associates the work request with the service class defined by the administrator. FIG. 4 shows the Open Group Application Response Measurement (ARM) interfaces that are invoked by the application 404 to provide the instrumentation used in a preferred implementation. Upon receiving the work request, the application 404 issues an arm_start_transaction( ) call to the agent 402. This call signals the agent 402 to start timing the transaction, and also gives the agent 402 information it uses to associate the work request with a service class. Upon completing the work request, the application issues an arm_stop_transaction( ) call to the agent 402. This call signals the agent 402 to stop timing the transaction and to record the response time for that transaction.

Referring now also to FIG. 5, the local agent 402 that records the response time of the work request periodically feeds the aggregated information for a number of work requests to the management server 308, which operates as a central collector in this aspect of its operation. As a work request passes from one server 304 to another, the agent 402 running on each server 304 keeps track of the work request via a “hop count”. This “hop count” allows the management server 308 to instantaneously build the application topology, as described in detail below. In contrast, current tools based on ARM require post-processing of log files that contain large amounts of data collected on each server and therefore cannot provide a real-time view of topology or performance data.

The management server 308 collects the data from the agents 402 and builds an overall performance view of the distributed transaction processing environment. The “hop count” mechanism and central collection of information provide a quick and easy representation of the server topology that is serving a specific work request. When performance targets are not being met, the management server 308 is able to pinpoint the server 304 in trouble immediately by using the topology and the performance data associated with each hop.

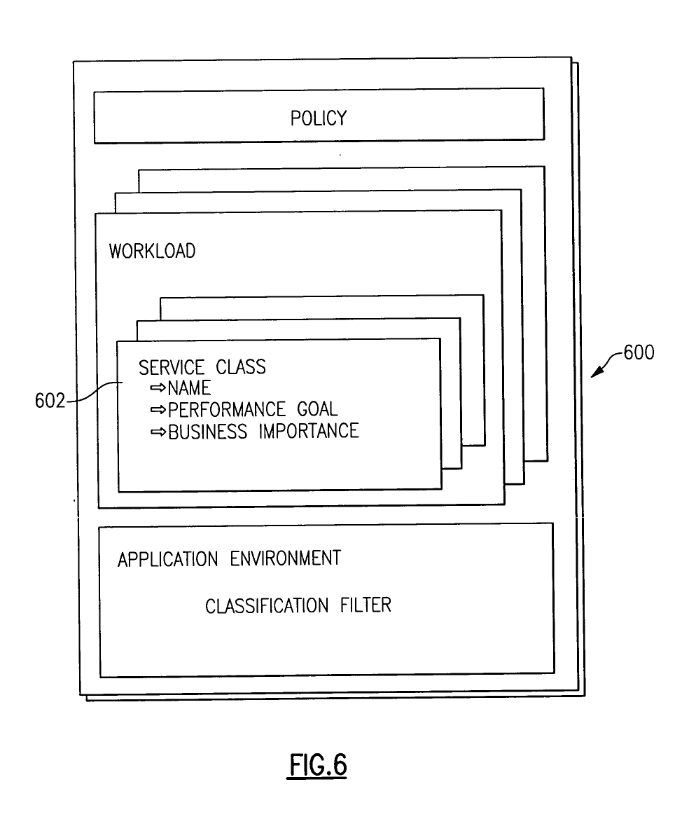

Referring to FIG. 6, a policy 600 organizes a transaction workload into service classes 602, each of which has a name, a performance goal (e.g., response time), and a business importance (i.e., priority). For each application environment 604, policy 600 contains a classification filter 606 for assigning transactions to end-to-end service classes and reporting classes, as well to a local reporting class. The operation of classification filter 606 is described in more detail below.

FIG. 7 shows at a system level the general configuration of the workload reporter of the present invention. The workload reporter operates in a distributed transaction processing environment 700 containing one or more systems 702 (here, two systems 702a and 702b), each of which contains one or more transaction processing applications 704 (here, respective applications 704a and 704b on systems 702a and 702b). Each system 702 corresponds to a operating system (OS) image and may comprise either a separate physical machine or a separate logical partition of a single physical machine. (More generally, a “system” can be merely a node of a network with its own local agent for collecting transaction data.) Although the IBM AIX operating system is shown for illustrative purposes, the particular choice of operating system is not critical. In the particular example shown in FIG. 7, application 704a is an Apache Web server, which directly handles requests for HTML documents from HTTP clients (i.e., Web browsers), while application 704b is an instance of the IBM WebSphere Application Server (WAS), which handles requests from the Apache Web server 704a. Such requests from the Web server 704a may occur when an Internet user is performing a query rather than requesting a preexisting HTML document.

In the example shown in FIG. 7, Web server 704a is considered a parent application performing a parent transaction on behalf of the Internet user, while application server 704b is considered a child application performing a child transaction on behalf of the Web server 704a in support of the parent transaction. Applications 704a and 704b form the simplest example of a call tree populated by applications 704, each of which may call one or more other applications 704 at the next level or “hop” in the tree. Although only a single “hop” is shown in FIG. 7, in general each child application 704 can initiate its own child transaction, resulting in an additional level in the tree. Also, while application 704a is shown as launching only a single child transaction, in general an application 704 may initiate multiple child transactions in support of a single parent transaction, creating multiple branches in the call tree. Call trees are discussed in more detail below in the section on correlation.

The workload reporter itself, indicated generally by the reference numeral 706, comprises several different components that interact with each other: an administrative user interface (UI) 708, a management server 710, and-one or more local agents (or “managed servers”) 712. The agents 712 are also referred to as workload managers, since their actual function is to manage as well as report on the workload of each local system, as discussed in the references cited above. However, since only their reporting function is relevant to the present invention, only that aspect of their operation is described.

Administrative UI 708 provides a simple graphical user interface (GUI) to create and administer a policy that represents the classes of service, types of work and rules that associate the work to the class of service. This component can be deployed on any workstation platform (e.g., Windows, Linux, etc.). Using a policy editor (not separately shown) a policy is defined stating the business objectives for the types of work expected to run across various servers in the reporting domain. Once a policy is defined it is passed to the management server 710, which is a focal point for collecting the reporting data. The definition of the management server 710 identifies the reporting domain. After installing a policy on the management server 710, it is activated across all the local agents 712. A policy can be activated using a simple click from the administrative UI 708. Once the policy is activated across all the local agents 712, the work requests that are instrumented are associated with the appropriate class of service, and each local agent 712 on a system 702 will start collecting response time and other statistics for the applications 704 running on that system 702.

The reporting data collected by each local agent 712 is transmitted to the management server 710 every 15 seconds in the preferred embodiment. The management server 710, operating as a central collector, gathers data from each local agent 712 and builds a consolidated report that can be extracted by the administrative UI 708 in real time.

Management server 710 maintains a global view of local agents 712 actively participating in the reporting domain. Management server 710 coordinates the entry of local agents 712 into and their exit from the reporting domain, interacting with each local agent 712 to maintain an accurate view of the state of the entire domain. Management server 710 also coordinates the activation of the policy across all the local agents 712 in the reporting domain, making sure that all the local agents 712 in the reporting domain run with the same policy. When a new local agent 712 and system 702 join the reporting domain, management server 710 ensures that a correct policy is activated on the newly joined system 702. Administrative UI 708 displays the domain topology and state of the system 702 and the current policy on the system 702.

As management server 710 receives reporting data from the local agents 712 it aggregates it into appropriate class-of-service and application environment structures. Management server 710 provides interfaces to obtain the following types of statistical data:

1. Snapshot of all available statistics

2. Service class summary data

3. Service class detailed data (for a specified class of service)

4. Application summary data (for a specific application, on behalf of a class of service)

5. Server (i.e., system) summary data (for a set of servers, on behalf of a class of service for an application)

6. Application topology

Each of the above reports is described below.

Management server 710 contains several components, including an administrative manager (AM) 714, a server manager (SM) 716, a policy manager (PM) 718, and a data manager (DM) 720. Their operation is described further below.

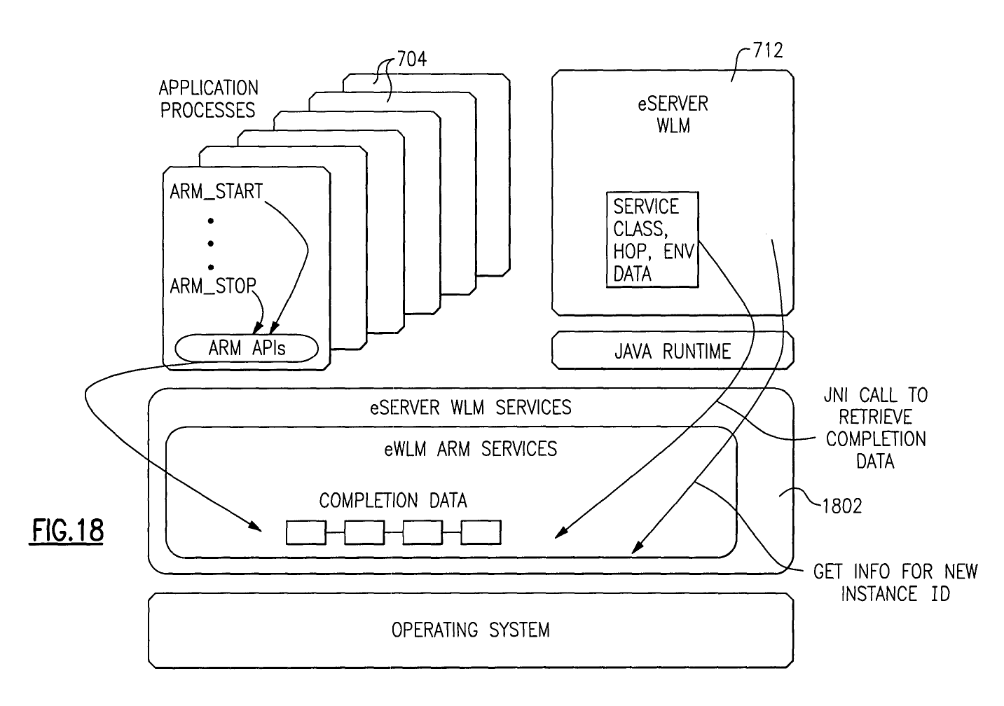

As described above, local agents 712 are deployed on the systems 702 with instrumented applications 704 whose response time is being monitored. When a local agent 712 starts it joins the reporting domain and obtains the policy that is activated from the management server 710 controlling the reporting domain. The policy is passed to an ARM services layer 1802 (FIG. 18), discussed further below, which builds appropriate data structures so that when an instrumented application 704 processes the work request it can properly classify the work to the appropriate class of service.

Each local agent 712 contains several components, including an environment agent (EA) 722, a server agent (SA) 724, a policy agent (PA) 726, and a data agent (DA) 728. Their operation is described further below.

As work flows through an instrumented application 704, the instrumented application 704 invokes ARM services. At the completion of the work request, the response time and other statistics are collected by the ARM services layer 1802 (FIG. 18). These statistics are then associated with the appropriate data structure that represents the business policy and application topology and passed to the management server 710, as described below.

The following discusses in more detail the subject of application instrumentation, which has already been referred to in passing.

In general there are two methods of monitoring or measuring work requests The first way is to use probes or “sniffers.” This involves code that intercepts the normal activity of an application and attempts to recognize the start and end of application work requests. The benefit of this approach is that it does not require changes to application software. However fast, reliable probes are difficult to build and each application requires its own unique probe. Also it is virtually impossible to correlate information obtained by separate probes without having the cooperation of the application.

The second way to collect data is to instrument the applications. This approach adds up-front costs: application vendors must update their software with the instrumentation, and customers then must upgrade their installed applications to the instrumented versions. However instrumentation is faster and more reliable than probes, and is the only practical way to correlate data across applications. Therefore this is the approach used by the workload reporter of the present invention.

Although the invention is not so limited, application instrumentation is preferably based on an Open Group Technical Standard known as the Application Response Measurement (ARM) application programming interface (API). The ARM API is designed to measure the response time and status of transactions executed by application software. In order to organize the information, each transaction is associated with an application and a transaction type. For this purpose:

1. An application is a piece of software that provides services to users upon request. Such applications are commonly called servers or middleware. (Since the term “server” is also often used to refer to the system on which the application is running, this specification will use the terms “system” and “application” in contexts where confusion might occur.) An instrumented process must define at least one application (typically only one).

2. A transaction type defines a type of transaction. The definition includes the names of properties that are known at the start of each transaction of the type, such as the identity of the user making the request, the object of the request, and so on. An instrumented process must define at least one transaction type for each application.

3. A transaction is a specific work request from a user. It has a well-defined start and completion. In the ARM API, the use of the term transaction does not imply any of the formal transactional properties of atomicity, consistency, isolation, and durability. Each transaction belongs to a particular transaction type. Each transaction is a member of a particular transaction class.

It is the application software designer's responsibility to decide what constitutes the applications, transaction type classes, and transactions within its products.

A brief history of the various ARM APIs follows.

ARM 1.0 was developed by IBM and HP and released by the ARM Working Group of the Computer Measurement Group (CMG) in June 1996. (It was never formally standardized). It provides a means to measure the response time and status of transactions. The interface is in the C programming language.

ARM 2.0 was developed by the ARM Working Group in 1997. It was approved as a standard of the Open Group in July 1998. It added the ability to correlate parent and child transactions and to collect other measurements associated with the transactions. ARM 2.0 is backward compatible with ARM 1.0. The interface is in the C programming language.

ARM 3.0 was approved as a standard of the Open Group in October 2001. It added some functionality, but it also deleted some important semantics (from the point of view of the present invention) from ARM 2.0. Most notably, it changed the way an application identifies its transactions from a string-based approach to an ID-based approach. This level of the interface is in the Java programming language. A C programming language interface of this level has not been specified.

The preferred embodiment uses extensions to the ARM standard to support functionality that is not available in either ARM 2.0 or ARM 3.0. Since the preferred embodiment supports instrumentation for both C and Java applications, and since currently there are separate standards that apply to each programming language, it uses a new version of the ARM standard that (1) is specified in both the C and Java programming languages; (2) restores semantics from ARM 2.0 needed by the workload reporter; and (3) adds new functionality needed by the workload reporter. These extensions, while forming no part of the present invention, are being considered by the Open Group in connection with proposed extended version of ARM called ARM 4.0.

The following is a brief description of the ARM 4.0 API for C programs, which is the assumed environment for the discussion that follows. (A comparable specification is provided for the Java environment.) More detailed descriptions appear later in this specification. The API consists of the following ‘core’ function calls which are used by all instrumented programs:

arm_init_application( ) defines an application. The key parameter is the application name which identifies the application for classification and reporting purposes. arm_init_application( ) is typically executed when the application initializes. The return value from arm_init_application( ) is a handle which is passed as a parameter on subsequent arm_init_transaction_type( ) and arm_end_application( ) calls. (Note: arm_init_application( ) is the ARM 4.0 equivalent of ARM 2.0's arm_init( ) function.)

arm_init_transaction_type( ) defines a transaction type. The key parameters are the transaction type name and (optionally) a list of names of properties that are known at the start of each transaction of the type. arm_init_transaction_type( ) is typically executed once for each transaction type while an application is initializing. The handle returned on a previous arm_init_application( ) call must be passed as a parameter on arm_init_transaction_type( ) so the transaction type is associated with the correct application. The return value from arm_init_transaction_type( ) is another handle which is passed as a parameter on arm_start_transaction( ) calls. (Note: arm_init_transaction_type( ) is the ARM 4.0 equivalent of ARM 2.0's arm_getid( ) function.)

arm_start_transaction( ) indicates that a transaction has begun execution. The handle returned on a previous arm_init_transaction_type( ) call must be passed as a parameter on arm_start_transaction( ) so the transaction is associated with the correct transaction type. The return value from arm_start_transaction( ) is a unique handle which is passed as a parameter on subsequent arm_blocked( ), arm_unblocked( ), and arm_stop_transaction( ) calls. (Note: arm_start_transaction( ) is the ARM 4.0 equivalent of ARM 2.0's arm_start( ) function.)

arm_stop_transaction( ) indicates that a transaction has completed and whether it was successful or unsuccessful. The handle returned on the preceding arm_start_transaction( ) call must be passed as a parameter to indicate which transaction is ending. (Note: arm_stop_transaction( ) is the ARM 4.0 equivalent of ARM 2.0's arm_stop( ) function.)

arm_end_application( ) indicates that the application will not be making any more calls to the ARM API. It is typically used when an application is shutting down. Transactions that are active (i.e. started and not yet stopped) are internally stopped by the workload reporter. (Note: arm_end_application( ) is the ARM 4.0 equivalent of ARM 2.0's arm_end( ) function.)

The API also supports the following optional function calls which may be used as warranted.

arm_blocked( ) indicates that processing of a transaction is blocked waiting for a transaction in another application to complete. This helps to identify what portion of a transaction's response time is spent in its own application and what portion is spent in downstream applications.

arm_unblocked( ) indicates that processing of a transaction is no longer blocked.

Below is a pseudocode example of a simple program that is instrumented with the ARM API. (This example is not intended to convey the actual syntax of the API calls.)

1 appl_id=arm_init_application(“Simple Web Server”)

2 tran_typeclass_id=arm_init_transaction_type(appl_id, “HTTP Get”, “URI”)

3 do until told to shut down

4 receive http get request

5 start_handletran_id=arm_start_transaction(tran_typeclass_id, uri)

6 process http get request

7 arm_stop_transaction(start_handletran_id, status)

8 end

9 arm_end_application(appl_id)

In line 1, the program calls arm_init application( ) to define an application called “Simple Web Server”. This name is the first piece of information that distinguishes the work that the program performs. arm_init_application( ) returns a handle for the application.

Next (line 2), the program calls arm_init_transaction_type( ) to define a transaction type called “HTTP Get” with one property called “URI”. The program passes the application handle returned by arm_init_application( ) to relate the transaction type to the application. arm_init_transaction_type( ) returns a new handle for the transaction type. The transaction type provides information about a type of work performed by the program (in this example it is the only type). If the program processed other types of work with different characteristics or properties, it could define additional transaction types for them.

The program then enters a request processing loop (lines 3-8). It calls arm_start_transaction( ) (line 5) and arm_stop_transaction( ) (line 7) to identify the beginning and ending of the processing (line 6) for each individual request (line 4). On arm_start_transaction( ), the program provides the transaction type handle returned by arm_init_transaction_type( ) and the actual URI property value for the transaction. arm_start_transaction( ) returns a handle for the transaction. On arm_stop_transaction( ), the program provides the transaction handle returned by arm_start_transaction( ) and the completion status of the transaction. This simple program processes all work requests serially under one thread. A more sophisticated program might process work requests in multiple threads.

Before the program ends, it calls arm_end_application( ) to delete the application it previously defined (line 9). It passes the application handle returned by arm_init_application( ).

FIG. 8 shows the structure of the ARM implementation in the preferred embodiment. As shown in FIG. 8, an application process 802 and a local agent process 804 interact via shared memory or operating system storage 806.

In the application process 802, an application 808 is dynamically linked to a shared library 810 that exports the ARM API function calls. The shared library code 810 calls system routines 812 to perform the requested function calls. The shared library 810 and the system routines 812 run under the application's thread. The system routines 812 use shared memory or system storage 806 to exchange data with the local agent 712, which runs in a separate process. In the local agent process 804, a local agent 814 similarly interfaces with the shared memory or system storage 806 via system routines 816 (which may be similar or identical to system routines 812).

The workload reporter processes the ARM function calls under the application's thread so that, in an enhanced version, it will be able to manage the application process according to the goals of the active transactions. The workload reporter needs to be able to relate the resource requirements of the process to the goal achievement of the active transactions. The system routines are designed to minimize path length as much as possible.

In a manner to be described below, the worlkoad reporter 706 (FIG. 7) gains an understanding of the flow of work across multiple heterogeneous operating system platforms and through multiple heterogeneous application environments. This is done through the interaction between the instrumented applications 704 and the workload reporter 706 via the instrumentation interfaces. Elements of this interaction include:

1. Application topology

Each execution process of an application 704 on a system 702 registers with the local agent 712 on that system 702. This allows the workload reporter 706 to dynamically construct the topology of services deployed throughout the configuration.

2. Classification

Each application 704 defines work classification properties available for each transaction.

This allows the workload reporter 706 to apply customer-defined rules to assign transactions into classes used for reporting.

3. Correlation

The flow of work between applications 704 is tracked by means of contextual information associated with each work request. This contextual information is called a correlator. Each application 704 provides interfaces to accept correlators with inbound work requests, and uses such interfaces in other applications 704 to send correlators with outbound work requests.

4. Data Collection

Each application 704 reports the arrival and departure of each transaction. This allows the workload reporter 706 to collect aggregated measurements describing the degree of participation of each application execution process.

The following portions of the specification explore these elements.

Each application process registers with the workload reporter 706 (more particularly, with the local agent 712 on the same system 702) during its initialization, using the arm_init_application( ) function call. An application 704 is identified by a set of properties (passed as strings):

1. An application name used by every instance of the application 704. This could be a product name or a software element name. In the preferred embodiment, an application name is required. It would include, if necessary, a version identifier for distinguishing different software levels of the application.

2. A group name used by a collection of instances of the application 704. This could be the name of a group of instances that process a shared workload. In the preferred embodiment, the group name is optional.

3. An instance name that is unique to each instance of the application 704 within a given system 702. In the preferred embodiment, the instance name is optional.

In the preferred embodiment, if an application 704 exists as multiple processes, it is registered from within each process. This allows the workload reporter 706 to understand how each process contributes to the application 704. Conversely, multiple applications 704 can be registered from within one process. This is useful if external functions that are perceived by end users as separate applications are packaged in the same process.

An “application environment” as used herein is a programming environment associated with an application product that performs a specific task. An application environment is defined in terms of the pair ProductName.GroupName, where ProductName is the above application name and GroupName is the above group name. For example, the WebSphere Application Server is an application product that handles two business applications: namely, StockTrades and StockAnalysis. An end user can separate out these applications in to two different application environments: WebSphere.StockTrades and WebSphere.StockAnalysis.

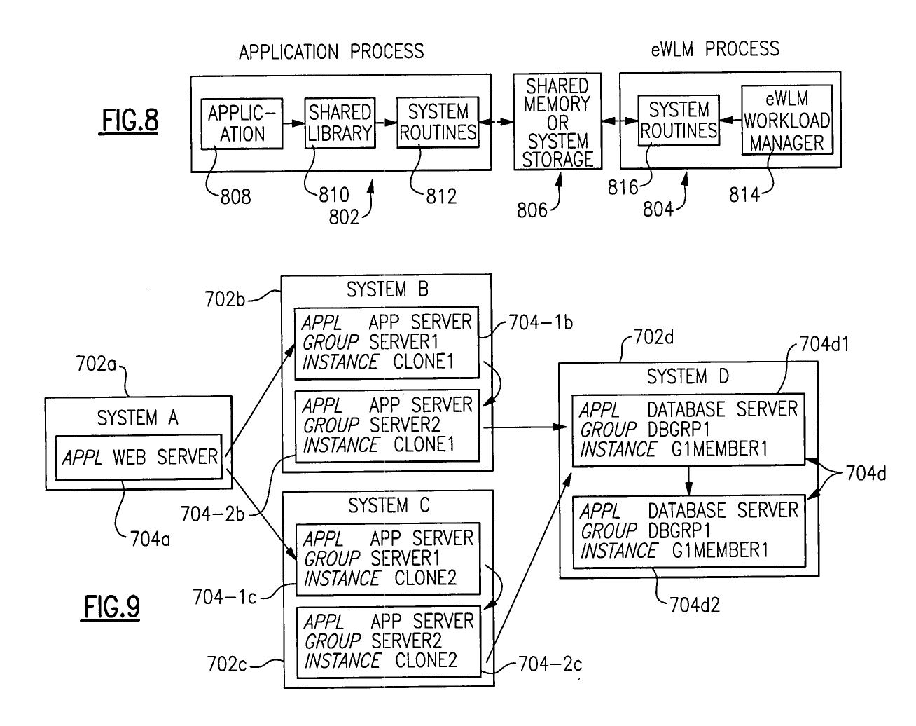

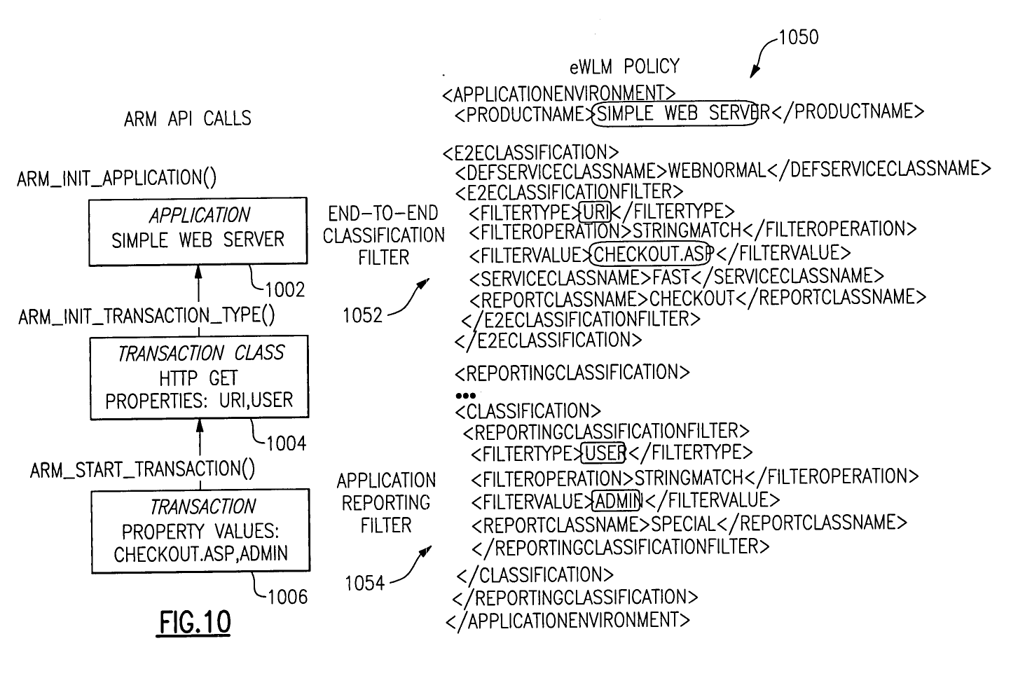

FIG. 9 shows an example of an application topology. (The examples in this specification use generic application names.)

FIG. 9 depicts the following applications 704:

1. A Web server 704a running on system 702a (System A), with an application name of “WebServer” (and no group or instance name).

2. Two application servers, server 704-1 (Server1) and 704-2 (Server2), each of which is cloned and deployed across systems 702b (System B) and 702c (System C). Server1 handles requests from the Web server. Some of these requests are forwarded on to Server2. Thus, on System B there is a first application 704-1b with an application name of “AppServer”, a group name of “Server1”, and an instance name of “Clone1”, together with a second application 704-2b with an application name of “AppServer”, a group name of “Server2”, and an instance name of “Clone1”. Similarly, on System C there is a first application 704-1c with an application name of “AppServer”, a group name of “Server1”, and an instance name of “Clone2”, together with a second application 704-2c with an application name of “AppServer”, a group name of “Server2”, and an instance name of “Clone2”.

3. A database server 704d, with an application name of “DatabaseServer”, running on system 702d (System D). The database server 704d is composed of a main process 704d1 which executes most SQL requests and an adjunct process 704d2 which executes stored procedures. Since both processes 704d1 and 704d2 belong to the same logical entity, both register with the same group name (“DBGrp1”) and instance name (G1Member1).

In FIG. 9 we have two application environments on both System B and System C. The two application environments on System B are running the application product “AppServer“: one with the group name of “Server1” and other with the group name of “Server2”. In other words, the two application environments on System B are AppServer.Server1 and AppServer.Server2. Similarly, the two application enviroments on System C are AppServer.Server1 and AppServer.Server2. Thus, we have two application instances for application environment AppServer.Server1. One instance is running on System B and other on System C. In end-to-end management policy, two application environments are defined: (1) Application Name=AppServer, Group Name=Server1; and (2) Application Name=AppServer, Group Name=Server2.

In accordance with the present invention, distributed workflows are represented as a series of hops. If a request flows across application processes on different systems 702, it is counted as a hop. If a request flows across application processes on the same system 702, it is counted as a hop if the two applications 704 have different application names or different application group names. In the FIG. 9 example, a Web request that runs a stored procedure would take 4 hops:

Hop 0: The Web server 704a

Hop 1: The Group 1 application server 704-1 (because the request flowed across systems, from System A to Systems B and C)

Hop 2: The Group2 application server 704-2 (because the request flowed across application groups, from application group Server1 to application group Server2)

Hop 3: The database server 704d (because the request flowed across systems, from Systems B and C to System D)

The adjunct process 704d2 of the database server 704d that runs the stored procedure is not counted as a fifth hop because it has the same application name and application group name as the database server's main process 704d1.

These hops are tracked using the correlators described below.

Each application 704 can deregister itself during its termination, using the arm_end_application( ) function call. If the ARM services layer 1802 (FIG. 18) detects that a process has terminated without deregistering its application(s) 704, it performs the deregistration itself.

The workload reporter 706 collects data into constructs called service classes and report classes. Thus, referring to FIG. 6, a policy 600 organizes a workload into service classes 602, each of which has a name, a performance goal, and a business importance assiciated with it.

The end-to-end management policy of the workload reporter 706 contains a set of hierarchical rules, called filters, for categorizing transactions into service and report classes. The process of assigning a transaction to a service class and a report class is called classification.

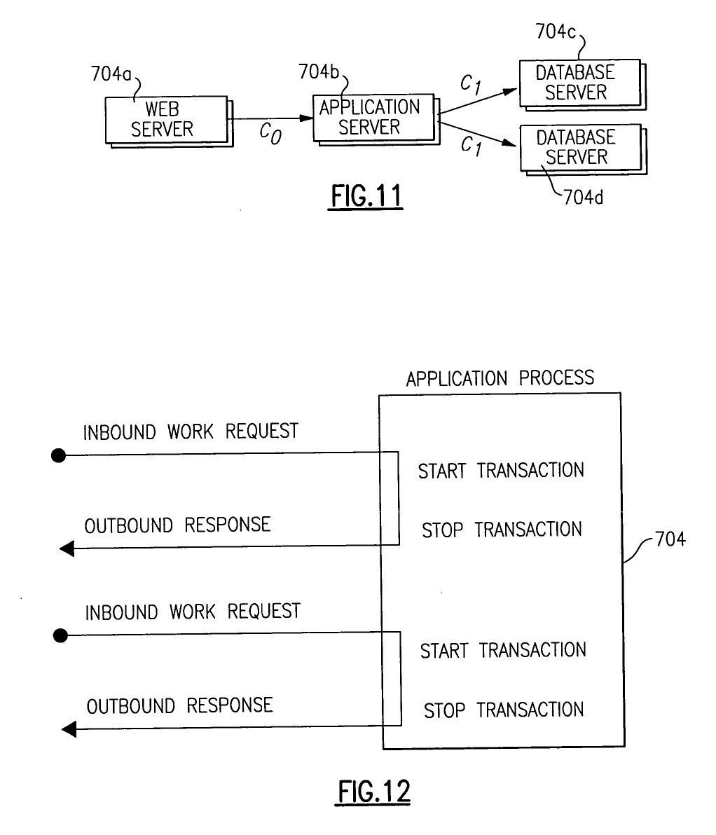

FIG. 10 illustrates how classification is performed. As shown in the left of the figure, an application 704 (FIG. 7) makes three ARM calls to the local agent 712:

1. An arm_init_application( ) call 1002 to identify the application 704 to the local agent 712 as having the name “Simple Web Server”.

2. An arm_init_transaction_type( ) call 1004 to identify a particular transaction type to the local agent 712 The arm_init_transaction_type( ) call 1004 identifies the transaction type as having the name “HTTP Get” and properties URI and User.

3. An arm_start_transaction( ) call 1006 to notify the local agent 712 of the start of a particular transaction having the property values URI=checkout.asp and User=admin.

Filters are organized by application 704. They can be created for an application name or for a combination of an application name and group name when more granularity is desired. The workload reporter 706 uses the names provided when the application 704 is defined (by the application 704 using the arm_init_application( ) function call 1002) to find the filters that apply to that application 704. Filters can test any of the transaction-level properties supplied by the application 704. The selection and naming of these properties is at the discretion of the application 704. Possibilities include the type of function being performed, the object being acted upon, and the identity of the user making the request. Since classification is performed at the start of a transaction only, it is normal to use values that are constant for the life of the transaction.

The application 704 identifies the set of valid transaction property names when it defines a transaction type using the arm_init_transaction_type( ) function call 1004. In the preferred embodiment, there is a maximum of 20 property names per transaction type, and each property name can be up to 127 characters long. Different property names can be defined for different transaction types.

The application 704 provides property values at the start of each transaction. A value is provided for each property name listed for that transaction type. In the preferred embodiment, each value can be up to 255 characters long. If there is no value for a given property, null can be specified.

In addition to the 20 application-defined transaction property values, the ARM API of the preferred embodiment also supports a separate property value specifically for an HTTP URL. It can be up to 1023 characters long.

Filters also can test certain “built-in” properties whose values are supplied by the workload reporter 706, such as the system name. Built-in properties have names starting with “ewlm” followed by a period. Applications should avoid defining property names that begin with these characters. If the application defines a property name that matches a built-in property name, the built-in property is used and the application's property is ignored.

As noted above, filters are contained in the policy applicable to a particular reporting domain. FIG. 10 shows the portion of an exemplary policy 1050, delimited by the XML tags <Application-Environment>and </ApplicationEnvironment>, that applies to a particular application environment having the product name “Simple Web Server”.

There are two types of filters: the end-to-end classification filter and the application reporting filter. Thus, the policy 1050 shown in FIG. 10 contains an end-to-end classification filter 1052 (delimited by tags <E2EClassification>and </E2EClassification>) and an application reporting filter 1054 (delimited by tags <ReportingClassification>and </ReportingClassification>).

The end-to-end classification filter 1052 assigns a service class and an end-to-end report class to a transaction. Thus, in the example shown in FIG. 10, transactions of type HTTP Get having the property value URI=checkout.asp are assigned to the service class Fast and report class Checkout. The filter 1052 is applied when a work request arrives at the first ARM-instrumented application 704 within a reporting domain. If the work request flows to other ARM-instrumented applications 704 on the same system 702 or on other systems 702 within the same reporting domain, the work request maintains its original service class and end-to-end report class. This depends upon application support of the ARM correlators. If a correlator is not passed along with the work request (perhaps because the interface does not support it), the chain is broken and the arrival of the work request in the next instrumented application begins a new end-to-end request. The same thing happens if a work request flows through an application that is linked to an ARM implementation not supported by the workload reporter 706.

The application reporting filter 1054 assigns an application environment report class to a transaction. Thus, in the example shown in FIG. 10, transactions having the property value User=admin are assigned to the report class Special. The filter 1054 is applied each time a work request arrives at an ARM-instrumented application 704. If the work request flows to other ARM-instrumented applications 704, the application environment report class does not flow with it.

As already noted, the processing of work requests in a distributed transaction processing environment 700 often involves multiple applications 704 that are distributed across multiple systems 702. FIG. 11 shows a common example involving a Web server 704a, an application server 704b, and a pair of database servers 704c and 704d.

What is perceived as one transaction may be implemented as many internal transactions in several different applications 704. In order to report data in a manner that matches the end-to-end view, the workload reporter 706 uses something that relates the internal transactions with one another. In the ARM API this is accomplished using correlators.

A correlator is a byte array that carries information from one internal transaction to another. Correlators are built by the ARM implementation. Applications 704 are not expected to interpret their contents. Applications 704 simply pass the correlators along with their work requests. Correlators may vary in size from one ARM implementation to another. In the preferred embodiment, an application 704 can obtain the length of a correlator using the arm_correlator_get_length( ) function call. The correlator used herein is approximately 100 bytes long.

As noted above, the flow of a request through a series of applications 704 can be viewed as a call tree of parent and child transactions. Each transaction in the tree has a unique correlator. Relationships are made by passing the correlator of the parent transaction to its child transactions. This is shown in FIG. 11, in which:

1. Web server 704a starts a transaction which is assigned correlator c₀.

2. Web server 704a sends a request to application server 704b and passes it the correlator c₀.

3. Application server 704b starts a child transaction and identifies the parent transaction using correlator c₀. The child transaction is assigned correlator c₀.

4. Application server 704b sends requests to two different database servers 704c and 704d. With each request, it passes the correlator c₁.

5. Each of database server 704a, 704b starts a child transaction and identifies the parent transaction using correlator c₁. The child transactions are assigned respective correlators c₃ and c₄.

In the ARM API, the application 704 passes the parent correlator (if one exists) to arm_start_transaction( ) and receives the child correlator back.

The workload reporter 706 uses the correlator to keep track of both end-to-end and local information. An example of end-to-end information is the service class. The workload reporter 706 propagates the service class from the parent correlator to the child correlator so that the data for all transactions in a call tree is collected into the same service class. An example of local information is the hop count, which represents the current depth into the call tree. The workload reporter 706 increments the hop count by 1 when constructing a child correlator from a parent correlator.

FIG. 26 shows the procedure 2600 for generating child correlators. The procedure 2600 is performed by the local agent 712 upon receiving notification from a calling application 704, in the form of an arm_start_transaction( ) call, of the beginning of a transaction. Upon receiving such notification, the local agent 712 constructs a child correlator to be returned to the calling application 704 (step 2602). If the calling application 704 passed a parent correlator (step 2604), the local agent 712 copies the end-to-end information (i.e., the service class and the report class) from the parent correlator to the child correlator (step 2606). The local agent 712 also increments the hop count of the parent correlator by 1 and copies to incremented count to the child correlator (step 2608). The local agent 712 then returns the child correlator to the calling application 704 (step 2610).

If at step 2604 the calling application 704 did not pass a parent correlator, that means that the calling application 704 is at the root of a call tree and is not a child application to any parent application for this transaction. In such case, the local agent 712 generates appropriate end-to-end information from the transaction data passed from the calling application 704, using the applicable classification filter, and copies this data into the child correlator (step 2612). The local agent also sets the hop count to 0 and copies this hop count into the child correlator (step 2614) before returning the child correlator to the calling application 704 at step 2610.

The correlator is what enables the workload reporter 706 to collect data for a distributed transaction and present it in a meaningful way. This is explored further below.

The ultimate purpose of the ARM API is, of course, to measure transactions. The workload reporter 706 uses the API to collect the following measurements:

1. Response times and transaction counts

2. Blocked and unblocked time

As shown in FIG. 12, an application 704 calls the ARM API when a transaction starts and ends. This allows the ARM implementation to count transactions and accumulate their response times. In the ARM API, the application 704 uses the arm_start_transaction( ) and arm_stop_transaction( ) function calls.

A transaction really refers to an individual work request into an application process. The start of the transaction occurs when the work request enters the application process. The end of the transaction occurs when the work request leaves the application process. It is these process-level boundaries that workload reporter 706 seeks to capture.

For applications 704 that process work requests within the context of a client connection, it is the individual work request flows, not the connection, that are instrumented. In order for the workload reporter 706 to perform consistent analysis of distributed work flows, all applications 704 use the same definition of a work request. Otherwise, problems occur. For example, if work flows from one application 704 that instruments individual request flows to another application 704 that instruments connections, it will be impossible to relate response time measurements between the two applications 704, or to manage the work to a single end-to-end goal.

The ARM API conforms to a request/response model. In this model, a child transaction always completes before its parent transaction does. There is no support for transactions that continue to execute beyond the completion of their parent transactions. If an application 704 has such transactions, they should be handled as separate end-to-end transactions (by not passing a parent correlator).

The ARM API allows an application to identify nested transactions within an application 704. For example an application 704 can break down a transaction that represents an external work request into nested child transactions that represent various subfunctions or processing stages of the external work request. The workload reporter 706 does not count such nested child transactions as hops, so the measurements for these nested transactions are not broken out in the workload reporter's end-to-end reporting. However the application reporting 1054 filter (FIG. 10) is applied and the measurements can be seen in application report classes. The workload reporter 706 does not collect measurements for such nested child transactions. If one is created, the following occurs:

1. No classification filters are applied.

2. When the nested child transaction is started, the workload reporter 706 assigns a transaction handle and builds a correlator that logically refer to the highest parent transaction within the process (which represents the external work request). This allows the application 704 to call the other transaction-level interfaces and to pass a valid correlator to other applications 704. Measurements derived through the use of the blocked/unblocked interfaces are attributed to the transaction representing the external work request.

3. When the nested child transaction is stopped, it is not counted as a transaction and no response time is accumulated since these measurements are imbedded in the transaction representing the external work request. The workload reporter 706 assigns the transaction handle value in such a way that it can distinguish the stopping of a nested child transaction from the stopping of the top parent transaction.

The above does not apply when the parent and child transactions are within different applications 704 within the same process. In this case, the workload reporter 706 considers this a “hop” and thus treats the parent and child transactions as distinct entities.

A transaction's response time is defined as the elapsed time between the stop time and the start time. In order for an application 704 to indicate the start of a transaction to ARM, it must know the transaction's identity in the form of the transaction-level property values. In most cases the time to gather this information is negligible, but in some applications there can be a nontrivial delay between the true arrival of the transaction into the application 704 and the time when the application 704 can identify the transaction to ARM. ARM provides a way for the application 704 to capture the actual arrival time of the transaction. In the ARM API, the application 704 can pass the arrival time to the arm_start_transaction( ) function call.

If a service class is not performing as expected, one piece of information helpful to isolating a problem is the time the transactions in the service class spend within each application 704. The application instance that contributes most to the average end-to-end response time should be focused on first to try to solve the problem. However the time spent in each application 704 is not directly available from the response time data measured by the ARM APIs. The issue is that the response time includes the time spent within any downstream applications 704 that also process the transaction. Using response times as a measure of the contribution of a given application instance to the transaction's end-to-end response time would be misleading. For example the largest response time may be in an application server, but the true problem may lie in a database server used by the application server.

In order to understand what portion of the response time is attributable to the application 704 itself, the ARM API allows the application 704 to indicate when it becomes blocked on another downstream application 704 and when it becomes unblocked. In the ARM API, the application 704 uses the arm_blocked( ) and arm_unblocked( ) function calls. These calls allow the workload reporter 706 to break down the response time into blocked and unblocked time, which improves the identification of application bottlenecks. In the above example the application server would still show the largest response times, but the blocked time would be high, indicating the problem lies downstream.

The blocked/unblocked functions are not intended to be used when a transaction becomes blocked on the application's own resources, such as when a transaction must wait for a lock to be available or for a local file system I/O to complete.

The blocked/unblocked functions allow a transaction to be blocked multiple times. Each call to block a transaction requires a corresponding call to unblock it. This allows these interfaces to be used when the application 704 processes a single transaction from multiple threads. The preferred embodiment considers a transaction to be blocked whenever there are any blocked calls outstanding.

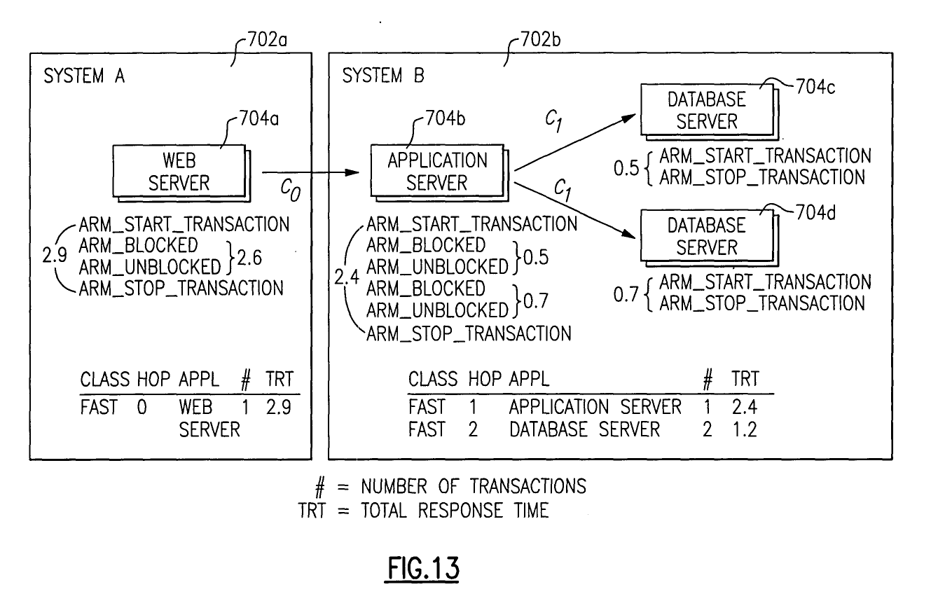

FIG. 13 illustrates how the workload reporter 706 collects transaction data from the ARM API.

Classification and correlation provide the infrastructure for data collection by the workload reporter 706. Classification assigns each end-to-end transaction to a service class and an end-to-end report class, which are the highest-level buckets for data. Correlation ensures the corresponding internal transactions are assigned to the same classes and provides a method of relating the internal transactions by the hop count.

FIG. 13 shows a single end-to-end transaction that begins processing in a Web server 704a on one system 702a (System A) and then hops to an application server 704b and a pair of database servers 704c and 704d on another system 702b (System B). The tables at the bottom of FIG. 13 show a logical view of what data each system would have collected at the end of this end-to-end transaction. Each table is keyed by class, hop count, and application. Assume this end-to-end transaction has been classified into service class Fast. (The data collection for the end-to-end report class is not shown but is similar.)

1. System A has recorded 1 transaction with a total response time of 2.9 seconds for service class Fast, in Web server 704a, at hop count 0. The transaction was blocked on application server 704b for 2.6 seconds, meaning Web server 704a contributed 0.3 seconds of elapsed time to the total response time.

2. System B has recorded 1 transaction with a total response time of 2.4 seconds for service class Fast, in application server 704b, at hop count 1. The transaction was blocked on database servers 704c and 704d for a total of 1.2 seconds, meaning application server 704b contributed 1.2 seconds of elapsed time to the total response time.

3. System B also has recorded 2 transactions with a total response time of 1.2 seconds for service class Fast, in database servers 704c and 704d, at hop count 2.

Periodically the local agent 712 pulls the data collected by the ARM API and sends it to the management server 710. The management server 710 assembles all of the data and makes various views of it available to reporting tools, whether they are part of the workload reporter 706 or otherwise.

The data agent 728 (FIG. 7) of each local agent 712 is responsible for the collection and aggregation of local performance management data generated by instrumented applications 704 through communication with the ARM services layer 1802 (FIG. 18) of the local agent 712. The data agent 728 maintains a set of data structures to organize the data retrieved from the ARM services layer 1802. Periodically (as specified by a StatisticsInterval object), interval data from these data structures is sent to the data manager 720 on the management server 710.

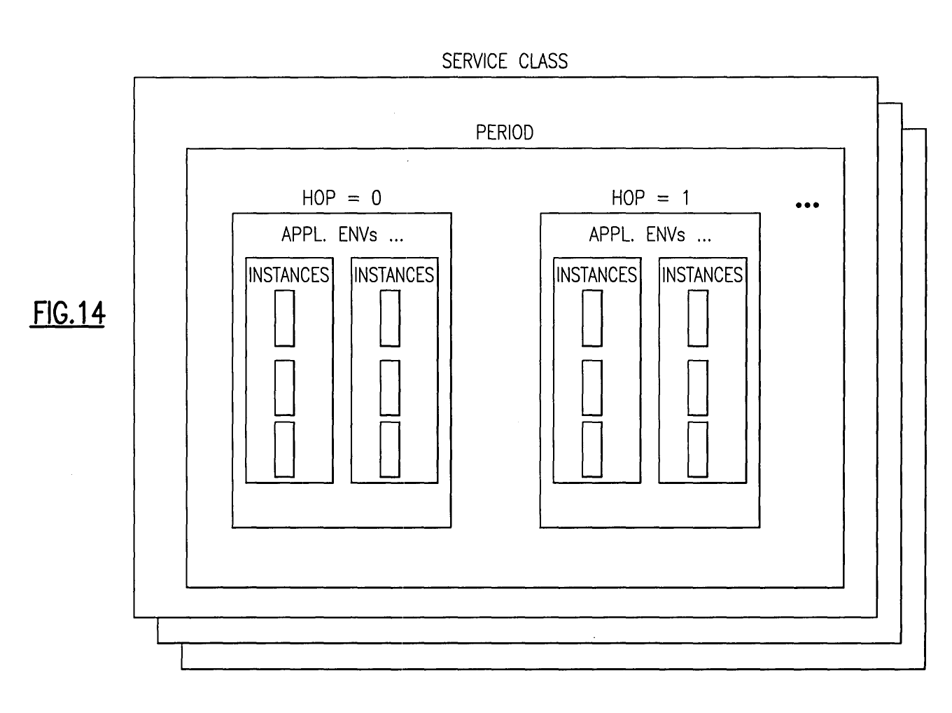

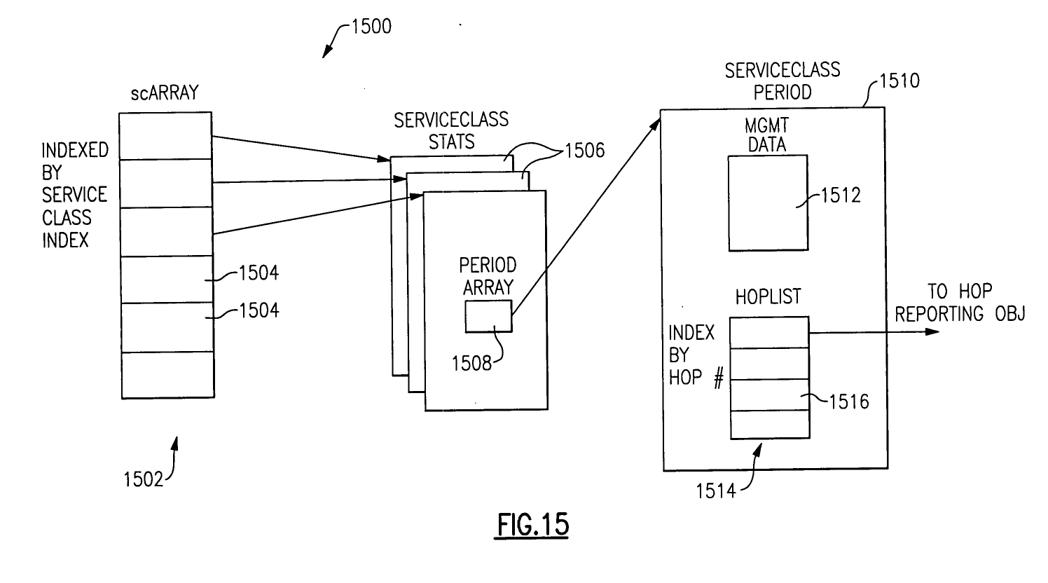

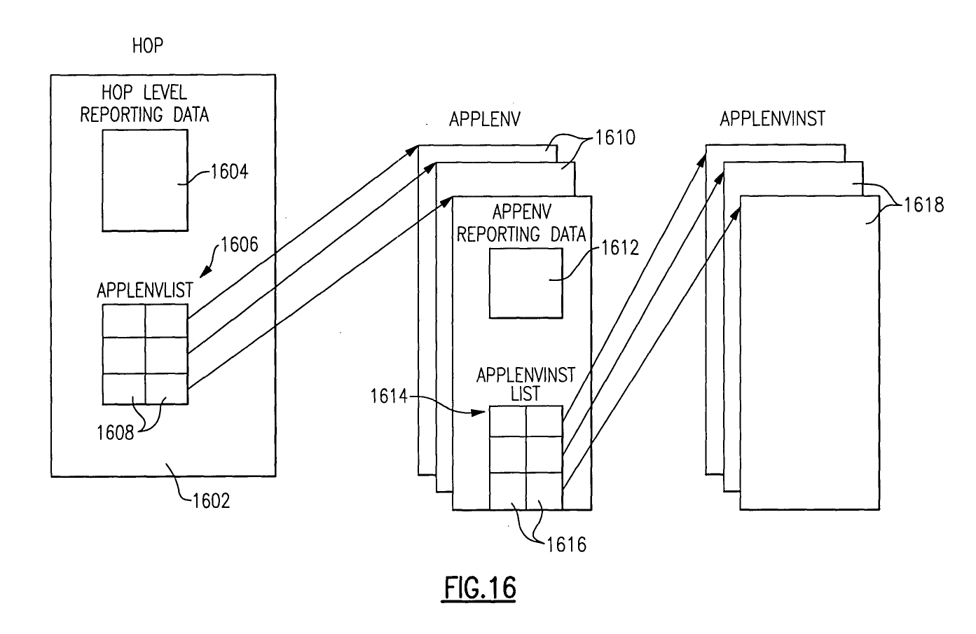

At initialization of the data agent 728 and whenever a new policy is activated, the data agent 728 builds the data structures for collection of the performance management data. This data structure is defined by a ServerStatisticsAccumulator object. FIG. 14 is a logical view of the hierarchy of the data kept in the ServerStatisticsAccumulator for service classes, while FIGS. 15-16 show the actual data structure 1500.

Referring first to FIGS. 14 and 15, at the highest level data is organized by service class. As shown in FIG. 15, a list 1502 (scArray) of entries 1504 corresponding to service classes is kept sorted by service class key. The sorting allows the list 1502 to be quickly searched for a service class by key. Each entry 1504 in list 1502 points to a structure 1506 for that service class. The next level in the hierarchy is the service class period. Although FIGS. 14 and 15 show only one period per service class, multiple periods may be defined within a single service class if desired. Each service class structure 1506 thus contains a period array of one or more entries 1508, each of which points to an object 1510 for that service class period. Each such object 1510 contains management data 1512 for that service class period. Within a service class period, the data is organized by hop. Accordingly, each service class period structure 1510 also contains a hop list 1514 (hopList), each entry 1516 of which points to an object 1602 (Hop in FIG. 16) for that hop.

Referring now to FIG. 16, each hop object 1602 contains hop-level reporting data 1604. Each hop can be made up of multiple application environments. For example, if a WebSphere Application Server (WAS) environment at hop 1 sends some transactions to DB2 and some transactions to CICS, there are two environments at hop 2: DB2 and CICS. Accordingly, each hop structure 1602 also contains an application environment list 1606 (applEnvList), each entry 1608 of which points to an object 1610 (ApplEnv) for that application environment. Each such object 1610 contains application environment reporting data 1612. The final level in the hierarchy is the application environment instance. Accordingly, each application environment structure 1610 also contains an application environment instance list 1614 (applEnvInstList), each entry 1616 of which points to an object 1618 (ApplEnvInst) for that application environment instance. The service class and service class period level in the hierarchy can be built based on the definition of the end-to-end policy. The rest of the hierarchy is discovered. That is to say, if completed transaction data indicates a hop, an application environment, or an application environment instance that is not already in the hierarchy, the hierarchy is augmented to include corresponding objects that can be populated with transaction data.

Each application environment and application environment instance has a unique identifier independent of service class assigned by the ARM services layer 1802 (FIG. 18). Each entry 1608 in the application environment list 1606 (applEnvList) in the Hop class is of class ApplEnvLocator. An ApplEnvLocator object 1608 is made up of the ID of the application environment and a reference to the instance 1610 of the ApplEnv class that represents that application environment. The applEnvList 1606 is kept sorted by the application environment ID. This allows a binary search to find the reference to the appropriate ApplEnv object 1610. The applEnvInstList 1614 in the ApplEnv class works in a similar fashion to allow a binary search to find the appropriate ApplEnvInst object 1618. The ApplEnvInst locator class is called ApplEnvInstLocator.

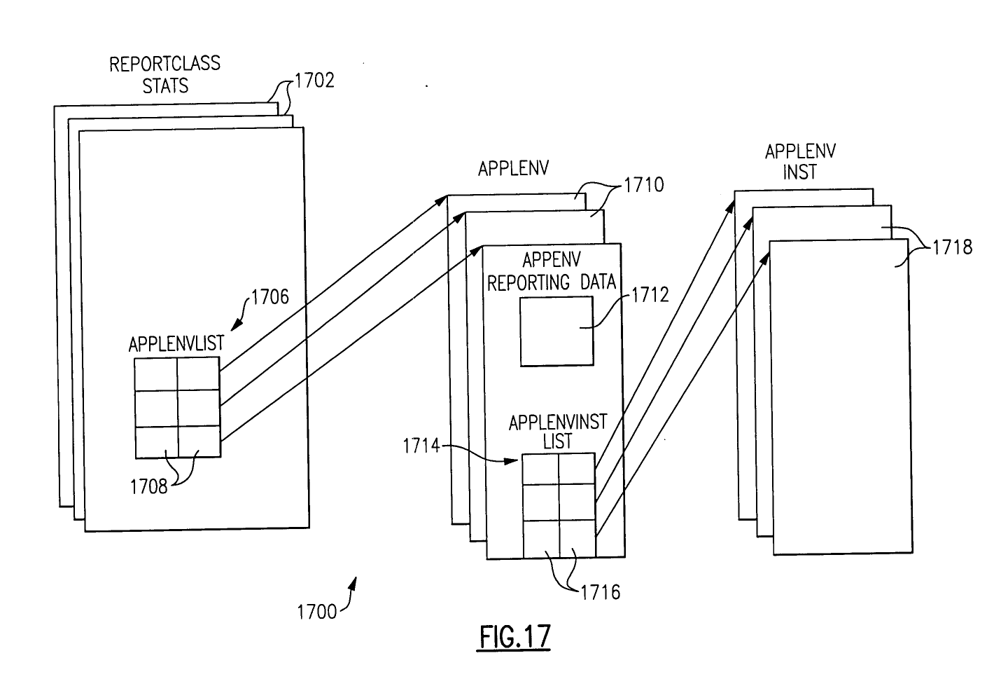

In addition to tracking statistics for each service class and each end-to-end report class, Server-StatisticsAccumulator tracks statistics by local report class. FIG. 17 shows the logical structure of the local report class data structure. The objects in this structure correspond generally to the similarly numbered objects in FIG. 16 and hence will not be separately described. Although not shown in FIG. 17, a preferred implementation of the local report class structure includes a hop level (which is always hop 0). This allows reuse of structures from the end-to-end report class structure.

To track application environments and application environment instances, the data agent 728 keeps an application environment instance table (not shown). This table is represented by the class ServerAppEnvInstInfo. There is one entry for each application environment instance sorted by the application environment instance ID using a TreeMap. (TreeMap is a Java class that is part of the Java Software Development Kit (SDK); it is shipped in the java.util package.) The application environment entries contain the identifying information for the application environment instances and their application environment including product name and application environment instance name. This identifying information is represented by the class ApplEnvInstDescriptor.

Referring now to FIG. 18, data agent 728 interacts with an ARM services layer 1802 associated with the local agent 712 to collect data about completed transactions and to discover new hops, application environments, and application environment instances. FIG. 18 shows an overview of these interactions.

The ARM services layer 1802 tracks data for each transaction completion. The local agent 712 retrieves the transaction completion data from the ARM services layer 1802 using an ewlm_get_trandata( ) call. Because the ewlm_get_trandata( ) call blocks, the call cannot be made from the main thread of data agent 728. Instead the data agent 728 creates a runnable subcomponent which is of class CompletionCollector. The ewlm_get_trandata( ) call blocks until sufficient transaction completions are collected or a timeout time is reached. In the preferred embodiment, the CompletionCollector component sets a timeout of 2 seconds. When ewlm_get_trandata( ) returns, the CompletionCollector component schedules the event NewCompletionsEvent to the data agent 728 to accumulate the completion data.

The following data is returned for each completion:

1. Transaction service class key

2. Transaction end-to-end report class key

3. Transaction local report class key

4. Application environment instance ID

5. Hop count

6. Transaction response time

7. Transaction blocked time

8. Transaction completion status (successful, aborted, failed, or unknown)

9. Parent server (i.e., system) UUID (needed for topology)

10. Parent application environment index (needed for topology)

11. Flags

For each completion the data agent 728 updates the ServerStatisticsAccumulator structures (FIGS. 15-17) for service class structure, report class structure, and the local report class based on the data for each completion returned by the ARM services layer 1802. As noted above, if completed transaction data indicates a hop, an application environment, or an application environment instance that is not already in the target data structure, that target data structure is augmented to include corresponding objects that can be populated with transaction data. If a completion entry contains an application environment ID that is not in the application environment instance tables, the data agent 728 calls the ARM service layer API ewlm_get_appldata( ) for the identification information about the instance and environment. The structure of this call is:

Input: Application environment instance ID

Output:

Application environment ID

Application product name

Application environment group name

Application environment instance name

PID

With the results of this call, the data agent 728 adds an ApplEnvInstDescriptor instance based on the returned information to the ServerApplEnvInstInfo structure. Then the data agent 728 sends a new applInstanceUpdate message to the data manager 720 on the management server 710.

If the flags for the completion indicate the completion represents a subtransaction within a hop, only the local report class data structure is updated.

If the flags for the completion indicate the application environment instance has terminated, the data agent 728 does the following. First it searches the ServerStatisticsUpdate for all occurrences of the terminating instances and builds a ServerStatisticsUpdate message with the last interval data for the terminating instances. This ServerStatisticsUpdate is sent to the data manager 720 on the management server 710. Then the data agent 728 deletes the instance from ServerStatisticsUpdate and the instance entry in ServerApplEnvInstInfo If the flags indicate a last instance in an application environment has terminated, the data agent 728 deletes the ApplEnv instances in ServerStatisticsAccumulator. Finally, the data agent 728 sends an ApplInstanceUpdate message to the data manager 720 on the management server 710.

If the flags for the completion indicate that the transaction was not classified under the current policy, the service class and report class indexes cannot be used. In this case the completion data is added to a default accumulator.

The data agent 728 interacts with the policy agent 726 so it can participate in policy activation. Data agent 728 participates in policy activation by building a new instance of ServerStatistics-Accumulator representing the new policy. At the start of the policy activation process, the data agent 728 receives a prepareForPolicyActivation event, which is then followed by a commitPreparedPolicy event or an abortPreparedPolicy event. If the new policy is committed, the data agent 728 sends a final set of interval data to the management server 710 from the old data structure and then discards the old data structure. The following describes how the data agent 728 processes each of these events:

1. prepareForPolicyActivation: Builds a new ServerStatisticsAccumulator instance based on the new policy but does not make it current. If in the process of building the new ServerStatisticsAccumulator an error is detected, a DataComponentException is thrown with a message providing details on the error. At this point the only error detected is a response time goal out of range. The exception is converted to a PolicyParticipantFailure. Any other exceptions taken when building the new ServerStatisticsAccumulator are also converted to a PolicyParticipantFailure.

2. commitPreparedPolicy: The data agent 728 sends the last interval performance data to the management server 710. The interval of this data is from the time the last interval data was sent until the time the Commit event was received. After the last interval data is sent, the data agent 728 discards the old ServerStatisticsAccumulator object and makes the new ServerStatisticsAccumulator object built during the Prepare event active.

3. abortPreparedPolicy: The data agent 728 discards the new data structure built during the Prepare event.

In the preferred embodiment, the data agent 728 uses an API provided by a native services layer (not shown) to collect overall server level statistics. Currently the statistics collected are CPU utilization and page fault rate. The data agent 728 calls this API in the same interval in which it sends a ServerStatisticsUpdate to the data manager 720 on the management server 710 and includes CPU utilization and page fault rate in the statistics update message.

The data agent 728 sends the following messages to the data manager 720 on the management server 710:

1. ServerStatisticsUpdate: Latest performance management statistics

2. ApplInstanceUpdate: Identifies to the data manager 720 an application environment that is known to the data manager 720. Also is used to notify the data manager 720 when the data agent 728 has been told by the ARM services layer 1802 that the identified instance has terminated.

The data agent 728 receives the following messages from the data manager 720:

1. GlobalStatisticsUpdate: Receive global performance statistics from the data manager 720. Also receive from the data manager 720 a mapping of server UUIDs and locally assigned application environment IDs to the global application environment IDs assigned by the data manager 720 . The global application environment ID is used to track the application environment topology.

Periodically the data agent 728 sends a ServerStatisticsUpdate message containing interval performance management reporting data to the data manager 720 on the management server 710. This interval is defined by the StatisticsInterval property. The message contains the identifier for the local server's active policy so that the management server 710 knows what policy the incoming data is associated with. During policy activation the data manager 720 maintains statistics from both the old and new policy. Otherwise if the policy ID does not match the current active policy, the data manager 720 discards the message. The message contains overall performance statistics for the local server (CPU utilization, page fault rate). In addition, the message contains one entry for each combination of service class, service class period, hop, application environment, and application environment instances on the local system 702. Application environment instances and their associated application environments are identified by their local IDs. Also the interval response time distribution is sent for every service class period with a response time goal and every report class with a response time benchmark. Finally for every application environment the message contains an array of counts of transaction received by parent application environment. This array is indexed by application environment global ID.

The following is the data sent in the data agent statistics update message:

1. Active policy ID

2. CPU utilization

3. Page fault rate

4. Logical CPU count

5. Total real memory

6. For each combination of service class, service class period (or report class), hop application environment, and application environment instances

a. class key

b. period number (only valid for service classes)

c. hop number

d. application environment ID

e. application environment instance ID

f. count of total transactions

g. count of successful transactions

h. count of aborted transactions

i. count of failed transactions

j. interval total response time

k. interval total active time

l. interval total queue time

7. For each service class period with a response time goal and every report class with a response time benchmark

a. interval response time distribution

8 For each application environment

a. array of counts of transaction received by parent application environment indexed by global application environment ID.

The data agent 728 sends an ApplInstanceUpdate message to the data manager 720 to provide a mapping between the local application environment and application environment instance ID to their identification information. Preferably this message is sent every interval by data agent 728 for every application environment instance. The reason it is sent every interval is avoid issues with data agent 728 and the data manager 720 getting out of sync if the communication with the management server 710 is disrupted. If a general resync capability with the management server 710 is provided, the message will need only to be sent when a new application environment instance appears and at resync time. The data sent on this message:

1. Message type (new instance message)

2. Product name

3. Group name

4. Instance name

5. Local application environment ID

6. Local application environment instance ID

7. process name

8. PID

An AppInstanceUpdate message is also sent when an instance is deleted. In that case the message contains:

1. Message type (delete message)

2. Local application environment instance ID of instance being deleted

The GlobalStatisticsUpdate message contains one entry for each service class period. Each entry contains an end-to-end response time distribution for the interval since the last time one of these messages was received. When data agent 728 receives this message, for each service class period, it adds the end-to-end response time distribution to the service class period's end-to-end service class period history.

The GlobalStatisticsUpdate also contains a mapping to find application environment global IDs. The map is an array where there is one entry for each local application environment ID assigned in the reporting domain. Each entry contains a local application environment ID, the UUID of the server (i.e., system) that assigned the ID, and the global ID for the application environment. The array is sorted by combination of server UUID and local ID, which allows a binary search to find the global ID of the parent application environment for a completion

Data manager 720 of management server 710 aggregates performance data from each local agent 712 in the reporting domain creating an end-to-end view of performance in the reporting domain. In alternative embodiments, the end-to-end view of the domain's performance management data may be made available to performance/systems management tools. In the embodiment shown, this data is only made available to a visualization tool (not separately shown) on the administrative UI 708 of the workload reporter 706 through private interfaces.

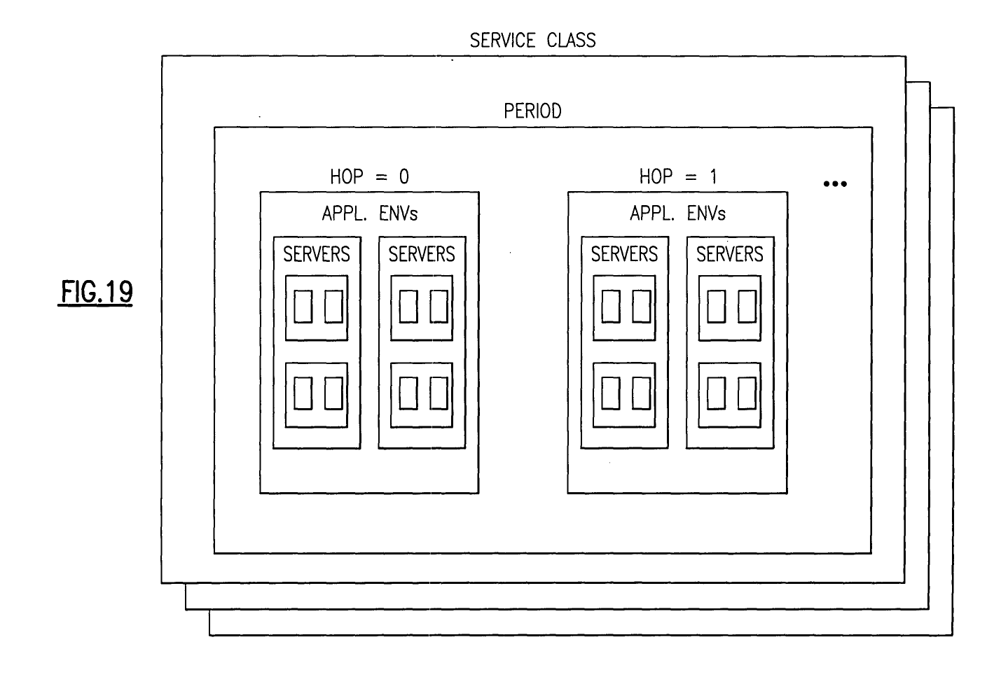

The primary data collection data structure used by data manager 720 is the GlobalStatistics-Accumulator class which is structured much like the ServerStatisticsAccumulator class of the data agent 728. The primary difference is that in the GlobalStatisticsAccumulator structure, application environment instances are organized by the server (=system, or OS image) on which they run. FIG. 19 shows the logical view of this data structure for service classes.

A similar data structure exists to collect end-to-end report class data. Application environments are identified by a global ID assigned by the data manager 720. The ID for an application environment instance is a combination of the connectId of the server on which the instance runs and the locally assigned ID for the instance.

During policy activation while there are still servers running with the old policy, there are two versions of GlobalStatisticsAccumulator. Data is still collected against the old policy until all servers have activated the new policy. Once a server has completed policy activation, its data is collected in the new instance of GlobalStatisticsAccumulator.

The data manager 720 also keeps a list of the application environments that have been identified to it (applEnvNameList). Each entry in this list represents one application environment and contains the application environment's product name and group name. Each unique combination of product name and group name is considered a different application environment. An application environment's index into this table is its global ID.

To track server-level performance statistics and map local server application environment IDs to the global application environment IDs, the data manager 720 maintains a server information data structure. The information kept for each server is represented by the ServerInfo class. Data manager 720 keeps an array of ServerInfo instances indexed by the server's connectId. Each instance of ServerInfo is used to keep that server's overall performance statistics. ServerInfo also contains an instance of ServerApplEnvInfo and an instance of ServerApplEnvInstInfo. ServerApplEnvInfo uses a TreeMap to map the local ID of an application environment to a description of the application environment (ApplEnvDescriptor). An ApplEnvDescriptor contains the identification information about the application environment and the application environment's global ID. ServerApplEnvInstInfo uses a TreeMap to map the local ID of an application environment instance to a description of that application environment instance (ApplEnvInstDescriptor).

Synchronization of all the data manager data structures is provided by the data manager thread. All references to these data structures are made while running under the data manager thread. However, if the data manager 720 fails, its parent component can free the data structure if it can verify that the data manager thread is no longer running

To support display of interval data in the visualization tool, data manager 720 uses a mechanism to keep interval statistics data. To support multiple visualization tool views at different intervals, data manager 720 is able to deal with multiple intervals in parallel. To maintain this interval data the class StatisticsDataBase is used. Each ServiceClass, Period, Hop, ApplEnv, and ApplEnvInst instance in the GlobalStatisticsAccumulator has a list of StatisticsDataBase instances representing the different intervals for which data is being collected. Every 10 seconds, the policy adjustment interval, data manager 720 goes through the GlobalStatisticsAccumulator and each StatisticsDataBase list to do interval processing for those StatisticsDataBase instances whose interval is over.

Data manager 720 receives two types of messages from the data agent 728 of each local agent 712 in the reporting domain. These message types are:

1. ApplInstanceUpdate: Identifies to the data manager 720 an application environment instance running on the sending data agent 728. Also informs data manager 720 when an application environment instance terminates.

2. ServerStatisticsUpdate: Latest performance management statistics from the sending data agent 728.

Data manager 720 also sends the following messages to each data agent 728 in the reporting domain:

1. GlobalStatisticsUpdate: Sends global performance statistics to each data agent 728 and the mapping to convert local application environment Ids to global application environment IDs.

When data manager 720 receives an ApplInstanceUpdate message representing a new application environment instance, it first checks to see if it has a ServerInfo instance for the sending server. If it does not have a ServerInfo instances for that server, it creates one. It then looks up the application environment instance ID in the ServerApplEnvInstInfo TreeMap. If the ID is not found, the ApplEnvInstDescriptor received in the message is added to the TreeMap. Next, data manager 720 looks up the application environment's local ID (from the message) in the ServerApplEnvInfo TreeMap. If it finds it, there is nothing else to do since a global ID has already been assigned to the application environment. Otherwise data manager 720 searches for the combination of product name and group name in the applEnvNamesList. This is a linear search but the search is an infrequent event so it should not be a performance issue. If the application environment is found, the index in the applEnvNameList represents the application environment global instance. Otherwise data manager 720 adds the combination of product name and group name to the end of applEnvNameList. Either way data manager 720 adds the application environments to the ServerApplEnvInfo for the sending system 712.

When data manager 720 receives an ApplInstanceUpdate message with delete indicator, it deletes the application environment instance from the GlobalStatisticsAccumulator and the ServerInfo instance for the sending system 712. If desired, a mechanism may b provided to notify reporting products that an application environment instance has been deleted so they can grab the final statistics for that instance.

When data manager 720 receives a ServerStatisticsUpdate message it does the following:

1. If policy activation is not in progress and the policy ID in the message does not match the ID of the currently active policy, the message is discarded. If policy activation is in progress and the policy ID in the message does not match either the new or old policy, the message is discarded.

2. Update system statistics (CPU utilization, page fault)

3. Loop through each interval response time distribution received and add each one to the proper service class or report class.

4. Loop for each application environment instances in the message. For each instance do the following:

a. Using the connectId of the system that sent the message and the local application environment ID, looks up in the corresponding ServerAppEnvInfo TreeMap the ApplEnvDescriptor which contains the environment's global ID. If the local application environment index is not found, the message is discarded and an ApplInstResync message is sent to the sending system 702.

b. Update the GlobalStatisticsAccumulator with the application instance statistics in the message. This might require adding the appropriate hop, application environment, and/or application environment instance levels to the data structure. Note if policy activation is in progress, then either the new or old data structure is updated depending on which policy the sending system 702 is running.

5 Loop through each application environment topology transaction count array in the message and add the array to the topology transaction count array for the appropriate application environment in the GlobalStatisticsAccumulator.

Data manager 720 participates in policy activation by building a new instance of the Global-StatisticsAccumulator representing the new policy. At the start of the policy activation process, data manager 720 receives an initiatePolicyActivation event which is then followed by a switchInitiatedPolicy event and then a completePolicyActivation event. During the window between initiatePolicyActivation and completePolicyActivation, servers begin to run with the new policy. This means that data manager 720 will begin to receive data based on the new policy. So data is not lost, data manager 720 keeps instances of GlobalStatisticsAccumulator for both the new and old policy and updates the proper instance as data is received from systems 702 running either policy. If a rollbackInitiatedPolicy is received, data manager 720 needs to continue the dual bookkeeping. However when completePolicyActivation is received after a rollbackInitiatedPolicy, the new GlobalStatisticsAccumulator instance is discarded and the old instance is made current again. Note that if desired, notifications may be given to reporting products of a rollback so they can retrieve data that might have been collected against the new policy before this data is discarded. The following describes how data manager 720 processes each of these events:

1.initiatePolicyActivation: Builds a new instance of GlobalStatisticsAccumulator based on the new policy. In the preferred embodiment, the service class and service class period levels of the data structures can be built entirely based on the policy. Data manager 720 also prepares for dual bookkeeping across the policy activation window.

2. switchInitiatedPolicy: This event is sent when enough systems 702 have activated the new policy so that the new policy is considered the “active policy” in the reporting domain. In the embodiment shown there is nothing for data manager 720 to do, dual bookkeeping must continue. In alternative embodiments this event may affect management actions

3. CompletePolicyActivation: Stops dual bookkeeping. Discards old GlobalStatistics-Accumulator instance.

4. rollbackInitiatedPolicy: Dual bookkeeping must continue. When the CompletePolicy-Activation event is received after a rollback, the new GlobalStatisticsAccumulator instance is discarded.

Data manager 720 sets up a listener for server topology changes. Data manager 720 is specifically interested in topology changes that indicate a server (i.e., a system 702) is leaving the configuration. When data manager 720 receives such notification, it removes all the application environments for that system 702 from the GlobalStatisticsAccumulator and removes the ServerInfo instance for that system 702. If desired, there may be a mechanism to ensure reporting products do not lose data when the system 702 is removed from the data structures. This may mean delaying the delete until reporting products have had a chance to get this data.

Data manager 720 also sets up listeners for the ServerStatisticsUpdate message and the ApplInstanceUpdate message.

The visualization tool on the administrative UI 708 makes requests to administrative manager 714 to receive performance data from data manager 720. Administrative manager 714 uses an instance of the DataRequest class to send the request to data manager 720 and must implement the DataRequestClient interface. The DataRequestClient interface defines two methods:

1. dataUpdate: This method is called when data agent 728 has new interval data ready for the requester. The input is an instance of the SnapShotData class.

2. complete: This method is called when the request is complete.

To make a request to data manager 720, administrative manager 714 creates an instance of DataRequest and then calls the startDataRequest method specifying the type of request, the interval for the request, and the number consecutive intervals in which to return data. Note that data is only returned on policy adjustment intervals so the interval time specified is rounded up to a multiple of 10 seconds. For a request that is for multiple intervals, data is immediately returned for the default interval (30 seconds in the embodiment shown). Data manager 720 always keeps 30-second interval data to allow it to be returned immediately. This allows the visualization tool to immediately display data. Subsequent data returned is on the interval specified rounded up to a multiple of 10 seconds. In the embodiment shown, only snapshot requests are supported. Calling startDataRequest results in an event being scheduled to data manager 720. To process this event, data manager 720 creates StatisticsDataBase instances for the requested interval and then adds them to the GlobalStatisticsAccumulator structure. When the interval is up, data manager 720 builds a SnapShotData object from the interval data in each StatisticsDataBase instances. The Data Request is then scheduled back to administrative manager 714. The administrative manager's dataUpdate method is called, passing the SnapShotData object. Data manager 720 repeats the process for the number of intervals specified building SnapShotData objects each time the interval is over and scheduling the DataRequest back to administrative manager 714. When the last interval is over the complete method is called. If data manager 720 encounters an error scheduling the DataRequest object back to the administrative manager 714, it ends the processing of the request. In this case the complete method is not called.

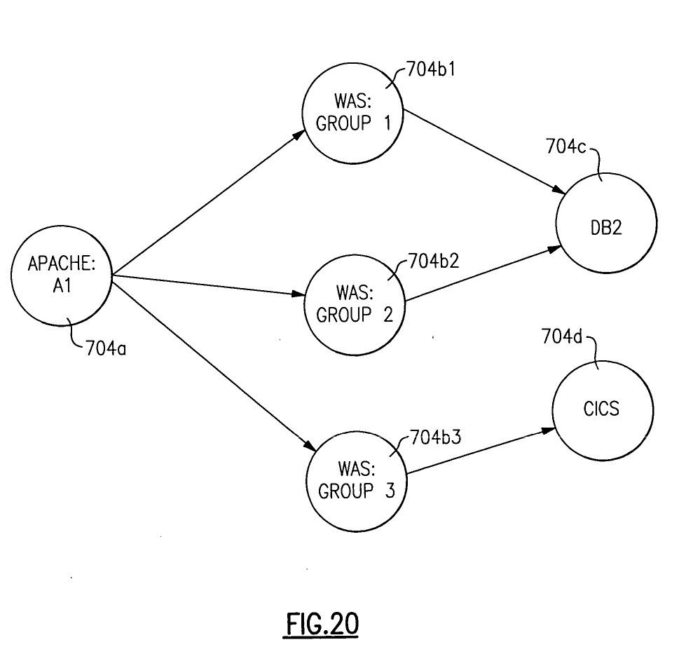

One of the reports that can be build by the data returned in a SnapShotData object is an application environment topology graph. FIG. 20 shows an example of what such a graph might look like. This figure shows an Apache Web server application 704a initiating transactions on three Web application server (WAS) applications 704b1-704b3, with WAS applications 704b1 and 704b2 initiating transactions on a DB2 database server application 704c and with WAS application 704b3 initiating a transaction on a CICS transaction server application 704d.

Preferably these diagrams are at the application environment level, not at the instance level. Keeping the data for instance level topology for a large configuration would likely require too much data to be kept.

This topology is represented in the SnapShotData object by having an array of transaction counts for each application environment. Each entry in the array is the count of transactions received from a specific parent application environment. The array is indexed by the parent application environment global ID.

To create these topology count arrays, each data agent 728 keeps such an array at the application environment level based on the parent application environment ID that it receives from the ARM services layer 1802 (FIG. 18). However the application environment ID provided by the ARM services layer 1802 is the local ID of the parent application environment on the parent system 702. Data agent 728 converts this local ID to the application environment global ID. To allow for this conversion, data manager 720 builds a mapping from system UUIDs and local application environment IDs to the application environment's global ID. This is represented as a list (applEnvIDMap) sorted by system UUID and local application environment ID. Data manager 720 sends this list to each data agent 728 as part of the GlobalStatisticsUpdate message. When the data agent 728 processes a completion, it uses the parent system UUID and parent local application environment ID to look up the parent application environment's global ID. It then updates the appropriate count in the completion application environment topology transaction count array. Each data agent 728 sends the interval transaction count array for each application environment to the data manager 720 as part of the ServerStatisticsUpdate message so that data manager 720 can merge the counts for each application environment across all the server where that application environment runs.

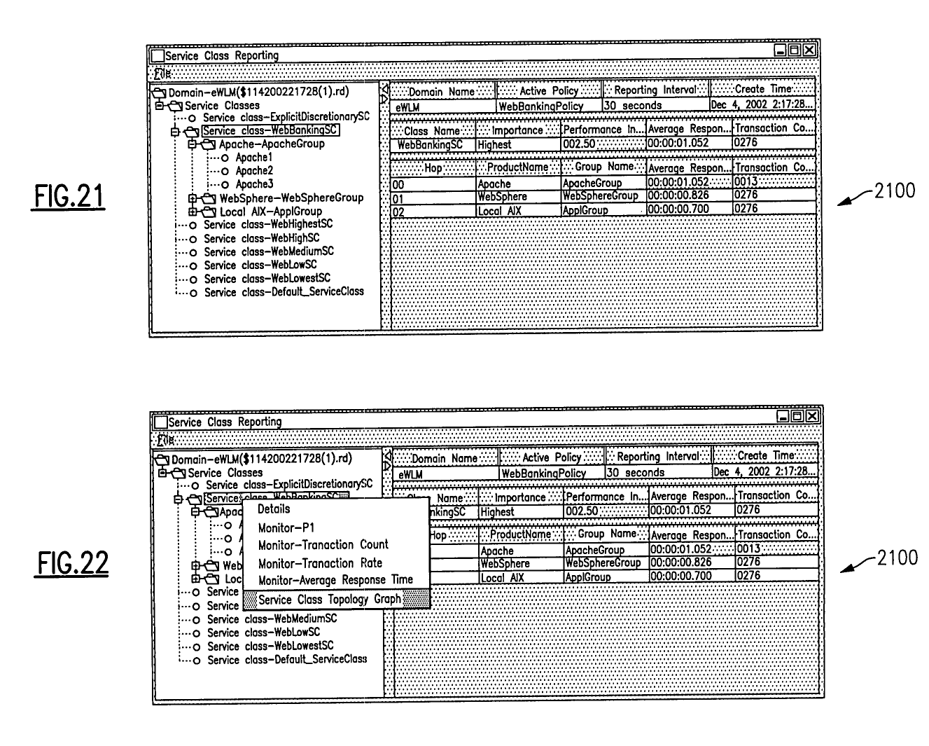

FIG. 21 shows a service class report 2100. This report 2100 describes all the service classes defined in a workload reporter policy 1050. If there are any applications 704 currently running under the service class, each application environment and the associated application instance is shown. From this report 2100 one can identify whether the application 704 is performing as desired or not. This report 2100 also shows the number of failed transactions. This is the starting place to further drill down into any performance problem. In this example WebBankingSC has a performance index value of 2.5, which indicates that goals are not being met. (More particularly, they are being missed by a factor of 2.5.)

The next step is to understand the logical tiers and the application environments that process the transaction for the service class. As shown in FIG. 22, one can select Service Class Topology Graph to view the logical tiers.

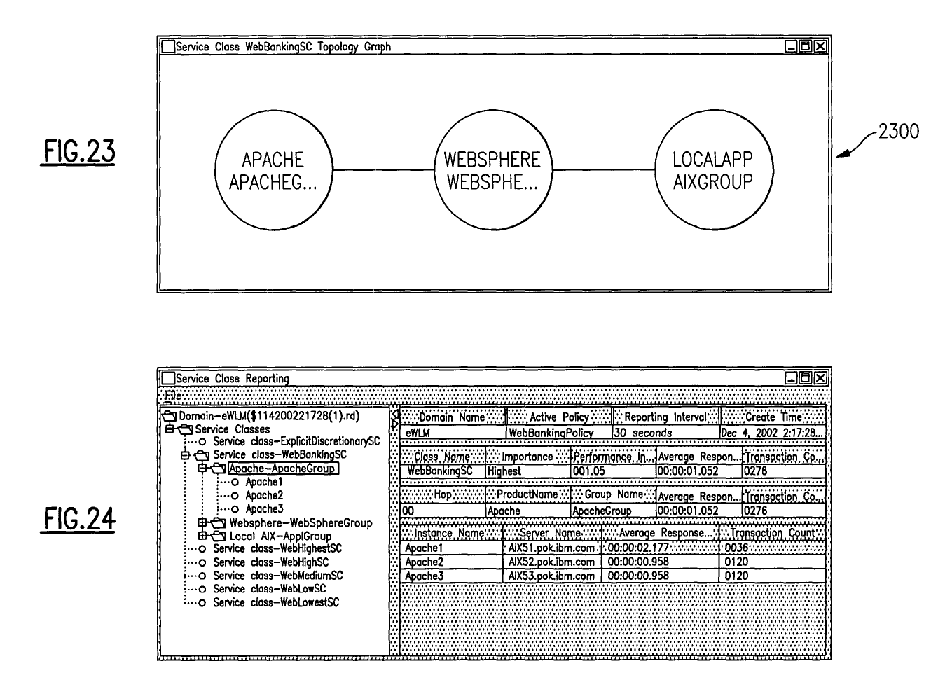

FIG. 23 shows a service class topology graph 2300. The service class topology graph 2300 shows the logical tiers involved in processing the service class, the application environments making up each tier, and the paths by which work in the service class are processed. Looking at this graph one can detect many conditions related to application performance.

1. An application environment without any paths leading from it or to it may indicate a configuration or network problem.

2. An application environment included that isn't supposed to be processing work in the service class could also indicate a network or routing problem.

From service class reporting, one can drill down further at application environment level. In the example above it looks like applications 704 in the Apache group are showing the highest response time. Many times users configure multiple instances of an application environment for availability and scalability. In the above example there are three instances of the Apache application environment.

To drill down further at the instance level, one can select application instance level reporting,. as shown in FIG. 24. In this example, Apache1 instance shows up with highest response time. To further understand the performance problem, one can look at the system where this instance is running. The workload reporter 706 provides ‘Systems Reporting’ to show the performance data of every system 702 participating in the reporting domain.

A systems report includes all the systems 702 that are currently participating in the reporting domain. For each system 702 following performance is provided:

1. Domain name

2. Active policy

3. Reporting interval

4. System name

5. Average CPU utilization

6. Average real memory

7. Average number of logical partitions

8. Number of page faults

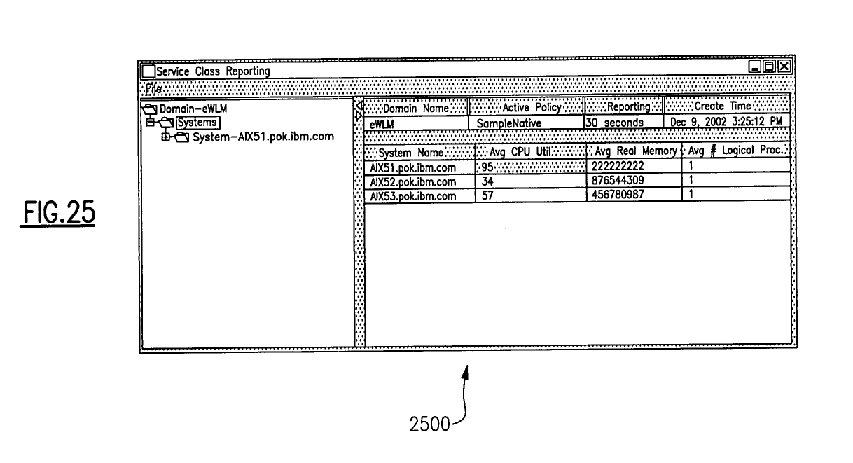

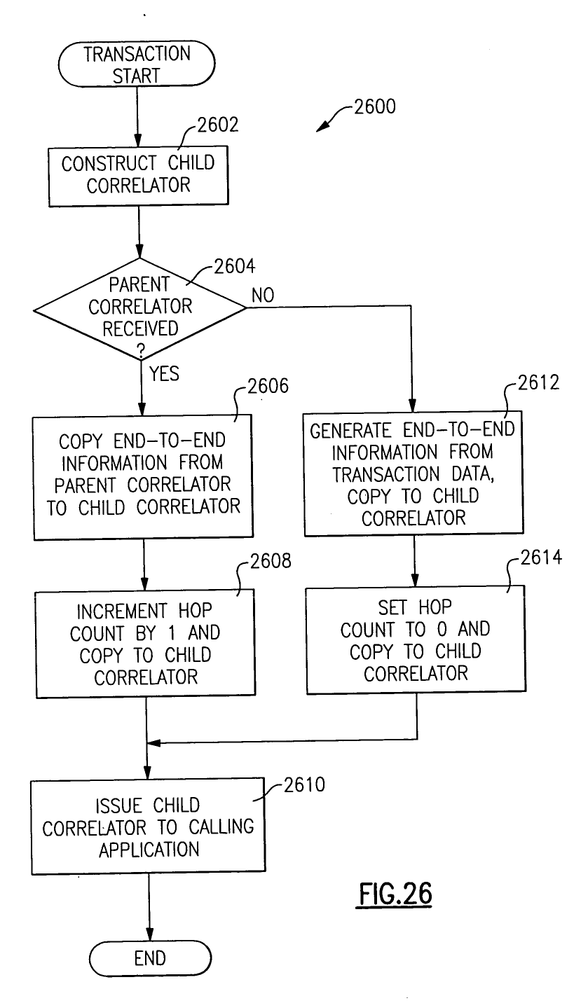

FIG. 25 shows an example of systems reporting in the form of a systems report 2500. In this example we notice that Apache1 is running on the system AIX51.pok.ibm.com. The system-level report shows that this system 702 is currently pegged at 95% CPU utilization. To narrow down the source of the performance problem from this point, one can use system-level tools available for the particular system 702.

The systems report 2500 also includes reports at the service class and application environment level. These reports are similar to those contained in the service class report 2100.

While a particular embodiment has been shown and described, it will be apparent to those skilled in the art that various modifications may be made without departing from the invention claimed herein. For example, one might use different criteria for what constitutes a separate “application” or “system” for the purpose of response measurement or topology construction. Still other modifications will be apparent to those skilled in the art.

What is claimed is:

1. A method of providing workload reporting in a distributed transaction processing environment having a call tree in which a child application performs a child transaction on behalf of a parent application performing a parent transaction, each of said applications being at a given depth in said call tree, said method comprising the steps of:
associating with each of said applications a hop count indicating the depth of said application in said call tree; and
using the hop count associated with each of said applications to construct a topology of said transaction processing environment in which said applications are represented in accordance with their depth in said call tree.

2. The method of claim 1 in which said parent application passes to said child application a child correlator correlating said parent transaction and said child transaction, said steps respectively comprising the steps of:
upon receiving notification of the beginning of a transaction from a parent application, issuing the parent application a child correlator to be passed on to a child application, said child correlator containing a hop count indicating the depth of said child application in said call tree; and
upon receiving said child correlator from said child application, using the hop count in said child correlator to construct a topology of said transaction processing environment in which said child application is represented in accordance with its depth in said call tree.

3. The method of claim 2 in which said notification of the beginning of said transaction from said parent application contains a parent correlator containing a hop count indicating the depth of said parent application in said call tree, said hop count in said child correlator being generated by incrementing the hop count in said parent correlator.

4. The method of claim 2 in which said child correlator contains end-to-end information commonly classifying transactions in said call tree, said step of constructing said topology comprising the step of using the end-to-information to classify said child transaction.

5. The method of claim 4 in which said notification of the beginning of said transaction from said parent application contains a parent correlator containing end-to-end information, said end-to-end information in said child correlator being generated from the end-to-end information in said parent correlator.

6. The method of claim 4 in which said classifying information indicates a service class.

7. The method of claim 4 in which said classifying information indicates a reporting class.

8. The method of claim 2 in which said distributed transaction processing environment comprises a plurality of systems, each of which contains one or more of said applications, said first step being performed by a local agent agent on a system containing said parent application, said second step being performed by a local agent on a system containing said child application.

9. The method of claim 8 in which the local agent on each of said systems records transaction data upon the completion of a transaction by an application on that system.

10. The method of claim 9 in which said local agents on said systems transmit recorded transaction data to a central collector.

11. Apparatus for providing workload reporting in a distributed transaction processing environment having a call tree in which a child application performs a child transaction on behalf of a parent application performing a parent transaction, each of said applications being at a given depth in said call tree, said apparatus comprising:
logic for associating with each of said applications a hop count indicating the depth of said application in said call tree; and
logic for using the hop count associated with each of said applications to construct a topology of said transaction processing environment in which said applications are represented in accordance with their depth in said call tree.

12. The apparatus of claim 11 in which said parent application passes to said child application a child correlator correlating said parent transaction and said child transaction, said logic respectively comprising:
logic responsive to receiving notification of the beginning of a transaction from a parent application for issuing the parent application a child correlator to be passed on to a child application, said child correlator containing a hop count indicating the depth of said child application in said call tree; and
logic responsive to receiving said child correlator from said child application for using the hop count in said child correlator to construct a topology of said transaction processing environment in which said child application is represented in accordance with its depth in said call tree.

13. The apparatus of claim 12 in which said notification of the beginning of said transaction from said parent application contains a parent correlator containing a hop count indicating the depth of said parent application in said call tree, said hop count in said child correlator being generated by incrementing the hop count in said parent correlator.

14. The apparatus of claim 12 in which said child correlator contains end-to-end information commonly classifying transactions in said call tree, said step of constructing said topology comprising the step of using the end-to-information to classify said child transaction.

15. The apparatus of claim 14 in which said notification of the beginning of said transaction from said parent application contains a parent correlator containing end-to-end information, said end-to-end information in said child correlator being generated from the end-to-end information in said parent correlator.

16. The apparatus of claim 14 in which said classifying information indicates a service class.

17. The apparatus of claim 14 in which said classifying information indicates a reporting class.

18. The apparatus of claim 12 in which said distributed transaction processing environment comprises a first system containing said parent application and a second system containing said child application, said apparatus comprising:
a first local agent agent on said first system for issuing said child correlator to said parent application; and
a second local agent on said second system for receiving said child correlator from said child application.

19. The apparatus of claim 18 in which the local agent on each of said systems records transaction data upon the completion of a transaction by an application on that system.

20. The apparatus of claim 19, further comprising a central collector for receiving recorded transaction data from said local agents.

21. A program storage device readable by a machine, tangibly embodying a program of instructions executable by the machine to perform method steps for providing workload reporting in a distributed transaction processing environment having a call tree in which a child application performs a child transaction on behalf of a parent application performing a parent transaction, each of said applications being at a given depth in said call tree, said method steps comprising:
associating with each of said applications a hop count indicating the depth of said application in said call tree; and
using the hop count associated with each of said applications to construct a topology of said transaction processing environment in which said applications are represented in accordance with their depth in said call tree.

22. The program storage device of claim 21 in which said parent application passes to said child application a child correlator correlating said parent transaction and said child transaction, said steps respectively comprising the steps of:
upon receiving notification of the beginning of a transaction from a parent application, issuing the parent application a child correlator to be passed on to a child application, said child correlator containing a hop count indicating the depth of said child application in said call tree; and
upon receiving said child correlator from said child application, using the hop count in said child correlator to construct a topology of said transaction processing environment in which said child application is represented in accordance with its depth in said call tree.

23. The program storage device of claim 22 in which said notification of the beginning of said transaction from said parent application contains a parent correlator containing a hop count indicating the depth of said parent application in said call tree, said hop count in said child correlator being generated by incrementing the hop count in said parent correlator.

24. The program storage device of claim 22 in which said child correlator contains end-to-end information commonly classifying transactions in said call tree, said step of constructing said topology comprising the step of using the end-to-information to classify said child transaction.

25. The program storage device of claim 24 in which said notification of the beginning of said transaction from said parent application contains a parent correlator containing end-to-end information, said end-to-end information in said child correlator being generated from the end-to-end information in said parent correlator.

26. The program storage device of claim 24 in which said classifying information indicates a service class.

27. The program storage device of claim 24 in which said classifying information indicates a reporting class.

28. The program storage device of claim 22 in which said distributed transaction processing environment comprises a plurality of systems, each of which contains one or more of said applications, said first step being performed by a local agent agent on a system containing said parent application, said second step being performed by a local agent on a system containing said child application.

29. The program storage device of claim 28 in which the local agent on each of said systems records transaction data upon the completion of a transaction by an application on that system.

30. The program storage device of claim 29 in which said local agents on said systems transmit recorded transaction data to a central collector.
